(19) United States
(12) Patent Application Publication
(10) Pub. No.: US 2002/0184047 A1
(43) Pub. Date: Dec. 5, 2002

(54) Universal ad queue

(76) Inventors: Michael A. Plotnick, Southampton, PA (US); Charles A. Eldering, Doylestown, PA (US); Douglas J. Ryder, Doylestown, PA (US)

Correspondence Address: EXPANSE NETWORKS, INC., 300 NORTH BROADSTREET, DOYLESTOWN, PA, 18901, US

(21) Appl. No.: 10/116,694

(22) Filed: Apr. 3, 2002

Related U.S. Application Data
(60) Provisional application No. 60/281,037, filed on Apr. 3, 2001.
(60) Provisional application No. 60/329,992, filed on Oct. 17, 2001.

(51) Int. Cl. G06F 17/60

(52) U.S. Cl. 705/1

(57) ABSTRACT

A “universal ad queue” (UAQ) is used for coordinating the display of at least two different types of advertisements to subscribers. The UAQ provides an ordered list for the display of ads to the subscribers. The ordered list may vary based on time, channel, program, previous ads, and subscriber type. The UAQ may be a single ad queue that tracks each and all of the different ad types. The single ad queue may be located at a single location or distributed amongst multiple locations. The UAQ may be multiple ad queues that are liked together in some fashion to coordinate the placement of ads in the various avails. The UAQ assists an advertiser in the creation and management of an overall ad campaign that utilizes the multitude of ad types that are available.

### BACKGROUND OF THE INVENTION

Conventional television advertising consisted of advertisements placed within broadcast television streams. More and more services have become available to television viewers (subscribers) and these new services provide additional advertisement opportunities. Advertisers and content providers need to take advantage of these new opportunities to reach the subscribers and create more revenue accordingly. With the introduction of some many new advertising opportunities there is a need for a system and method to coordinate ad campaigns to take advantage of the various different ad opportunities. Further, there is a need for a system and method for targeting ads to subscribers in each of these new opportunities. Moreover, there is a need to coordinate the targeting of these different advertisement types.

The Video Cassette Recorder (VCR) is an integral part of most households. According to Statistical Abstracts of the United States, as of 1998 98.3% of US households had at least one television (the average number of television sets per home was 2.4) and 84.6% of TV households had at least one VCR. The Personal Video Recorder (PVR) is a term that is generally used to describe the digital equivalent of the VCR. PVRs are also known as Digital Video Recorders (DVRs) and when located outside of the residence can also be referred to as Personal Video Channels (PVCs).

Because VCRs are so universally accepted, it is clear that a digital successor technology will eventually take hold. That digital successor technology will provide the functionality of the VCR but with the added flexibility of a digital platform. The advent of the Internet will also have a significant impact on the successor technology to the VCR because Internet based delivery, storage and in-home distribution of multimedia content will allow for new PVR functionality and architectures.

VCRs have a fast-forward capability that allows the user to fast-forward through programming. One of the primary uses of the fast-forward button is to skip commercials in pre-recorded material. That is, users who have gone through the trouble to pre-record a program typically have no interest in viewing the advertisements. Because the use of VCRs to record programming for home use is considered “fair use” in terms of copyright, programmers and advertisers cannot prevent manufacturers from supplying VCRs or putting fast-forward functionality on VCRs, nor can they prevent consumers from using the fast-forward button to skip commercials.

PVRs, like the predecessor VCR, will have a fast-forward capability. Some manufacturers have even gone so far as to put a “commercial skip” button on the PVR that allows the user to completely skips over the advertisement with the touch of a button. Although there are copyright issues that may ultimately prevent the PVR manufacturer from including an explicit “commercial skip” button, PVR users will likely insist on the ability to fast-forward through commercials.

In a traditional VCR/PVR, the video is meaningless when the user fast-forwards or rewinds, and the audio is suppressed. The viewer cannot typically recognize the advertisement of the manufacturer, and there is therefore little chance to make an impression on the viewer. For the foregoing reasons, there is a need for a method and system for presenting a brief marketing message when a user fast-forwards through or rewinds through an advertisement.

The PVR also provides for the insertion of ads (likely targeted ads) locally. In effect this creates an individualized ad campaign for each subscriber. Thus, there is a need for an apparatus and method for coordinating the local insertion of all of the various ad types for each subscriber. Furthermore, there is a need for monitoring the individualized ad campaign and modifying the ad campaign if necessary.

### SUMMARY OF THE INVENTION

The current invention is directed to system and method for coordinating the display of various advertisement types to subscribers. The method includes detecting an advertisement opportunity (“avail”). The avail detected can be for at least two different types of advertisements. According to a preferred embodiment of the current invention, there is coordination amongst the various avail types, playlists, and ad queues. This coordination will be referred to herein as a “universal ad queue” (UAQ).

The UAQ may be a single ad queue that tracks each and all of the different avails for a content delivery system. The single ad queue may be located at a single location or distributed amongst multiple locations. The UAQ may be multiple ad queues that are liked together in some fashion to coordinate the placement of ads in the various avails. The UAQ may be other variations that would be known to those of ordinary skill in the art. The UAQ links various ad type s to each other so that an advertiser can create and manage an overall ad campaign that utilizes the multitude of ad types that are available. According to one embodiment, the ads may be targeted to the subscribers.

In one embodiment, the UAQ is generated within the content delivery system by an ad management system, a traffic and billing system, or other systems known to be involved in the placement of ads in programming. The content delivery system receives instructions from a plurality of advertisers. The instructions define the advertisers ad campaign for associated ads including at least some subset of type of ads, preferences, links with other ads or ad types, and number of times to be displayed. The advertiser instructions are processed to create the UAQ. The UAQ provides an ordered list for at least two different types of ads. There can be any type of ads or combinations of ads in the queue, the ads in the queue may be linked to other ads, other events, time or criteria.

The UAQ is used to select ads to place in avails. The UAQ provides pointers to the ads so that they can be retrieved and inserted. The UAQ may be maintained by the video delivery network, the PVR, or some combination thereof. The ads may also be stored by the ads may be stored video delivery network, the PVR, or some combination thereof. The ads defined in the UAQ may be targeted ads. The UAQ may be a single queue defining all the various aspects or may be individual ad queues that are linked together in some fashion.

According to one embodiment, a method, system and computer program for coordinating the display of various advertisement types to subscribers is disclosed. An avail is detected, wherein the avail detected can be for at least two different types of advertisements. A universal ad queue is queried to determine which advertisement should be inserted in the avail, wherein the universal ad queue provides an ordered list for at least two different types of advertisements. The advertisements are retrieved and inserted in the avail and then delivered to the subscriber.

According to one embodiment, a method, system and computer program for generating a universal ad queue is disclosed. Instructions are received from a plurality of advertisers, wherein the instructions define their advertisement campaign for associated advertisements, including at least some subset of type of advertisements, preferences, links with other advertisements or advertisement types, and number of times to be displayed. The instructions are processed to create the universal ad queue, wherein the universal ad queue provides an ordered list for at least two different types of advertisements.

According to one embodiment a personal video recorder (PVR) for presenting advertisements to a subscriber is disclosed. The PVR includes an interface for receiving video programming; a universal ad queue containing an ordered list of at least two different types of advertisements; a detector for detecting avails within the video programming; a selector for selecting an advertisement from the universal ad queue for insertion in the avail; an inserter for inserting the advertisement into the avail; and a modulator for modulating the video programming with the advertisement inserted therein to the subscriber.

These and other features and objects of the invention will be more fully understood from the following detailed description of the preferred embodiments that should be read in light of the accompanying drawings.

### BRIEF DESCRIPTION OF THE DRAWINGS

The accompanying drawings, which are incorporated in and form a part of the specification, illustrate the embodiments of the present invention and, together with the description serve to explain the principles of the invention.

In the drawings:

FIG. 1A illustrates an exemplary content delivery system;

FIG. 1B illustrates exemplary video delivery networks

FIGS. 2A-B illustrates exemplary advertisement opportunities;

FIG. 3 illustrates an exemplary playlist;

FIG. 4-7 illustrate several different exemplary ad queues;

FIG. 8 illustrates an exemplary ad queue, wherein the ad is associated with time of day and program type preferences;

FIG. 9 illustrates an exemplary linkage table between EPG ads and programming ads;

FIG. 10 illustrates exemplary linkages between EPG ads and programming ads;

FIG. 11 illustrates an exemplary embodiment of a Universal Ad Queue (UAQ) that coordinates the display of EPG ads with programming ads;

FIG. 12 illustrates an alternative exemplary embodiment of the UAQ that coordinate the display of EPG ads with programming ads;

FIG. 13 illustrates an exemplary embodiment of a UAQ that defines separate queue based on network and day part;

FIG. 14 illustrates an exemplary cable TV (CTV) system;

FIG. 15 illustrates an exemplary table correlating subscribers to cable network components;

FIG. 16 illustrates an exemplary head-end for delivering target ads to a subzone level;

FIG. 17 illustrates an exemplary head-end for delivering target ads to a microzone level;

FIG. 18 illustrates an exemplary UAQ, wherein each slot has an ad identified by an advertisement resource locator (ARL) and a description of the type of avail each ad can be placed;

FIG. 19 illustrates an exemplary UAQ in which the various avail types are defined and an ad is associated with the applicable avail types for each ad; and

FIG. 20 illustrates an exemplary playlist.

### DETAILED DESCRIPTION OF THE PREFERRED EMBODIMENT

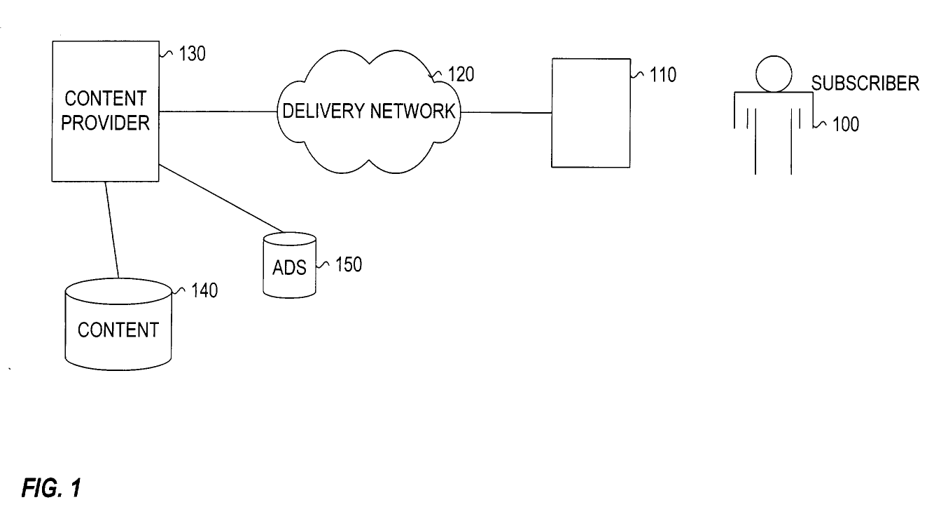

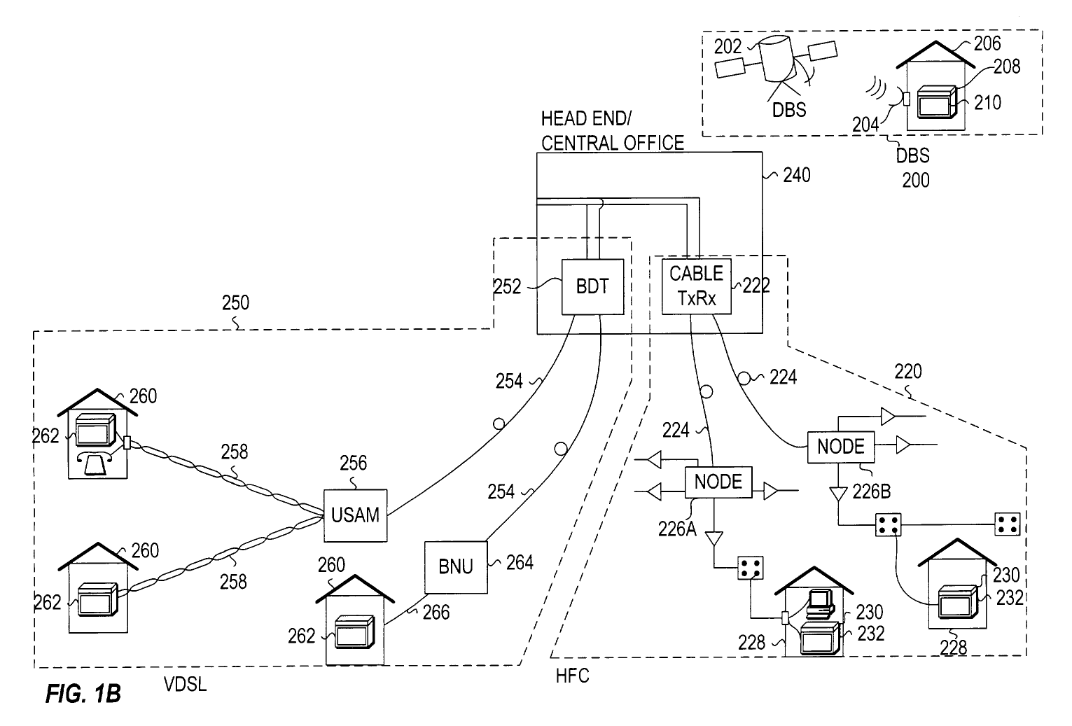

In describing a preferred embodiment of the invention illustrated in the drawings, specific terminology will be used for the sake of clarity. However, the invention is not intended to be limited to the specific terms so selected, and it is to be understood that each specific term includes all technical equivalents which operate in a similar manner to accomplish a similar purpose. With reference to the drawings, in general, and FIGS. 1 through 20 in particular, the present invention is disclosed.

Content delivery systems deliver content to subscribers. The content may be transmitted to the subscribers as a broadcast where multiple subscribers receive the same content (i.e., radio, television). Alternatively, the content may be transmitted to individual subscribers, such as when the subscriber requests the content (i.e., content on demand). The content may be video, audio, computer programs, computer applications, data or other content that would be well known to those of ordinary skill in the art. Advertisements (ads) may be delivered in addition to the content. The ads may be delivered prior to, after, within breaks in, in conjunction with or during the content. According to one embodiment, the ads are targeted to the subscribers. The targeting may be to a specific area (i.e., node in a cable system), to a group of households, individual households, a group of subscribers, individual subscribers or other means that would be obvious to those of ordinary skill in the art.

FIG. 1A illustrates an exemplary content delivery system. A subscriber 100 can select particular content to interact with at their interaction device 110. The interaction device 110 is the interface for the subscriber 100 to select content that they wish to receive. The interaction device 110 transmits requests for content to a content provider 130 via a delivery network 120. The interaction device 110 also receives the content from the content provider 130 via the delivery network 120 and provides the content to the subscriber 100. The interaction device 110 may be a television (TV), a set top box (STB), a computer, a personal video recorder (PVR), a wireless device (i.e., phone, personal digital assistant (PDA)), or other devices that would be obvious to those of ordinary skill in the art. The content may be viewed, heard, other means known to those of ordinary skill in the art, or some combination thereof by the subscriber 100 on the interaction device 110. The delivery network 120 may be the Internet, a private network, a cable television network, a telephony network, a satellite network, a terrestrial wireless network, or other types of networks that would be obvious to those skilled in the art. Possible delivery network 120 architectures include but are not limited to hybrid fiber coax (HFC), fiber to the curb (FTTC), fiber to the home (FTTH), digital broadcast satellite (DBS), multichannel multipoint distribution systems (MMDS), local multipoint distribution systems (LMDS), or any of the twisted wire pair digital subscriber loops (xDSL) including high speed (HDSL), asymmetric (ADSL), very high speed (VDSL), and rate adaptive (RADSL).

The content provider 130 provides access to a multitude of content. The content provider 130 may be limited to a specific type of content (i.e., video) or may be capable of providing a multitude of different formats of content (i.e., digital video, analog video, audio, and IP streaming media). The content may be stored by the content provider 130 in a content database 140 or the content provider 130 may simply act as a pass through for the content (receive from source and transmit to subscriber). The content database 140 may be any type of storage devices now known or later discovered. While, the content database 140 is illustrated as a single database it should be obvious to one of ordinary skill in the art that the content may be stored in more than one database and that the databases may in fact be distributed databases that are not even in a central location. In a preferred embodiment, the content provider 130 also has access to an advertisement database 150. The content provider 130 selects ads from the ad database 150 that would be applicable (i.e., targeted) to the subscriber 100. While the ad database 150 is illustrated as being connected to the content provider 130, it may be maintained by others than the content provider 130 and the results simply provided to the content provider 130 or the ads may actually be stored and inserted at the subscriber side (i.e., interactive device 110). Discussions of possible ways to target and deliver the ads will be described in more detail later.

While the invention is intended to cover any kind of content that a subscriber 100 may receive (broadcast or on-demand), for ease of discussion this application will concentrate on video delivery systems. When used herewithin the term video delivery network will be used to describe all of the various types of delivery networks, including any video or content delivery networks, that are now known or are later discovered. FIG. 1B illustrates exemplary embodiments of three of the more common types of video delivery networks (DBS 200, HFC 220, and xDSL 250).

A DBS system 200 transmits a programming stream comprising upwards of a hundred channels of programming directly from a geo-stationary satellite transmitter 202 orbiting the earth to a receiving antenna 204 mounted on or near each subscriber's house 206. The programming stream is transmitted from the antenna 204 via a cable (not shown) to a satellite receiving station 208 in the form of a set-top box (STB) in the subscriber's house 206. The satellite receiving station (i.e., STB) 208 selects a channel and demodulates the signal for delivery to a monitor 210, such as a television. Most DBS systems 200 are arranged such that data can also be sent in the upstream direction, that is, from the STB 208 to the DBS provider. In most DBS systems 200, the STB 208 also is coupled to the telephone line and is designed and programmed to place telephone calls to the DBS service provider to periodically send information in the upstream direction. Such information commonly may comprise requests for Pay-Per-View (PPV) programs, requests for changes in the subscription (a request that one or more of premium channels be added to the service, etc.).

A HFC network 220, such as digital cable network, transmits multiple channels of TV information from a head end or central office (HE/CO) 240 via a cable network 222. Particularly, the channels are transmitted via cables 224, such as fiber optic cables, to nodes 226. The nodes 226 are essentially switching/routing stations that service multiple homes (usually a few hundred). The nodes 226 route the signals to individual subscriber households 228. For digital cable, the individual subscriber households 228 will have STBs 230 that select a particular channel from the transmit stream, demodulate it and forward it for display on one or more monitors (i.e., televisions) 232. Upstream information may be sent from the STB 230 to the HE/CO 240 via a dedicated upstream channel over the cable. In cable systems that do not support two-way communication, the upstream “channel” can be through the telephone as described above in connection with DBS systems 200.

A xDSL system 250 transmits programming over the regular telephone network. Particularly, TV signals are transmitted from a broadband distribution terminal (BDT) 252 within the HE/CO 240 via cables 254, such as fiber optic cables, to a universal service access multiplexer (USAM) 256 that delivers the data to multiple individual subscriber households 260 via regular telephone twisted wire pair 258 using VDSL modems and protocols. The USAM 256 receives a wide bandwidth signal comprising some or all of the television channels. However, because of the bandwidth limitations of twisted pair wire, typically only a limited number of channels of television programming (i.e., one to three) at a time can be delivered from the USAM 256 to the household. Accordingly, the subscriber has a STB 262 that is similar in functionality to the previously discussed STBs 232 for DBS and CTV, except that when the user changes channels such as by operating a remote control, the remote channel change signal is received by the STB 262 and transmitted to the USAM 256 which switches the channel for the user and begins sending the newly selected channel to the household.

Such systems are known as switched digital video (SDV) systems. SDV systems are essentially fully modem asynchronous two-way communication networks. Accordingly, the STB 262 can transmit information upstream via the same VDSL modem that receives the downstream signals. SDV systems typically operate using an asynchronous transfer mode (ATM) protocol that is well known in the networking arts. In an alternative embodiment, the TV signals are transmitted from the BDT 252 to a broadband network unit (BNU) 264. The BNU 264 delivers the data to individual households 260 using coaxial cable 266.

The delivery systems described with respect to FIG. 1B can deliver programming in various forms, including but not limited to digital video, analog video, or IP streaming media. The programming may be compressed in accordance with a variety of now known or later discovered compression standards, such as the current Motion Picture Expert Group (MPEG-2) standard for digital video.

It should be noted that STBs are described above with reference to FIG. 1B. The current invention does not necessarily require STBs and in fact can use any other devices that can perform the same, similar, or additional functions. These devices may include, but are not limited to TVs, Video Cassette Recorders (VCR), Digital Video Recorders (DVR), Personal Video Recorders (PVR), Residential Gateways (RG), in home networking devices, and computers. For simplicity, the term STB will be used herein to represent all the various devices that interact between the delivery network and the viewing device and the term PVR will be used herein to represent devices that contain memory and are capable of storing relatively large amounts of information (i.e., programming content) thereon.

Ads are displayed to subscribers in ad opportunities (avails). There are numerous types of avails that ads can be displayed in. The most common type of avail is the avail associated with a break in television programming (programming avails). When one normally talks about ads in programming (programming ads) they are referring to typical commercial spots (i.e., 30 second) that are displayed in broadcast, network or cable programming, such as ABC, NBC, ESPN, CNN, or a local cable station. However, programming ads may also be associated with and inserted in Video on Demand (VoD) programming, Pay Per View (PPV) programming, and recorded programming. Moreover, it is possible that programming ads are also associated with and inserted in avails within program guides (discussed in more detail later).

The avails for VoD (VoD avails) or PPV (PPV avails) would typically be for ads either before (pre-pend) of after (post-pend) the video that has been selected. The pre-pend/post-pend ads may be typical ads (i.e., 30 second spot for products or services), previews for other content (i.e., other videos available on demand, other PPV events), infomercials, other known types of ads, or a combination thereof. It should be noted the VoD avails and PPV avails may also be during the programming depending of the programming and billing option selected. For example, ads may be delivered in the middle of an old episode of “I Love Lucy” that was selected as the VoD content at what would be typical commercial breaks, ads may be inserted in the middle of a long movie selected as the VoD content as a built in break in the movie, or ads may be inserted during rounds of a championship PPV boxing match. Applicants' co-pending patent applications previously incorporated in their entirety by reference (but not admitted to be prior art) and identified by docket numbers T742-00 (provisional) and T742-10 describe advertising in VoD in greater detail.

Avails also may be associated with programming that is recorded for future viewing (recording avails). As would be obvious to one of ordinary skill in the art, programming (and associated ads) can be recorded as the programming is viewed, while the subscriber is viewing other content (i.e., another channel) or while the subscriber is not even interacting with a viewing device, such as the TV, and in fact the viewing device may be off. The ads that are displayed to the subscriber when the subscriber is playing back the content may be the ads that were displayed while that programming was being broadcast, separate ads that are inserted while the programming was being recorded, or ads that are inserted as the programming is played back. As one of ordinary skill in the art would recognize, if the ads displayed during playback are other than those displayed in the program as it is broadcast or recorded, it is likely that the ads are being inserted at the subscriber end (i.e., STB, PVR). It should also be noted that if ads are being inserted as the programming is being played back (at the subscriber end), it is possible for the ads to be inserted in different (or additional) avails than those that were available when the programming was broadcast (i.e., pre-pend, post-pend). The specifics of local (subscriber end) ad insertion will be discussed in more detail later. Moreover, as one of ordinary skill in the art would recognize, if the programming were recorded for future playback, there is the potential that subscribers may fast forward through, or skip advertisements. The implications of this will be discussed in more detail later.

Virtual avails (a variety of opportunities to advertise within the programming itself) may also be available. Virtual avails include, but are not limited to, overlay avails, product placement avails and bug avails. Overlay ads, product placement ads and bugs are accordingly placed in these virtual avails. Overlay ads can be defined as ads that are inserted in available or blank space in the programming, such as on the wall of a sport arena. Product placement ads can be defined as products that are placed in the programming, such as an actor drinking a Pepsi. Advertisement “bugs” can be defined as an image that is overlaid on a portion of the screen, such as the network logos that are often displayed in the comer of the programming. Techniques for performing virtual ad insertion including background overlays and product placement are well known to those skilled in the art and are described in U.S. Pat. Nos. 5,543,856; 5,627,915; 5,808,695; 5,892,554; 5,593,076; 6,100,925; and 6,184,937 all of which are herein incorporated by reference.

Program guides are often used to present the content that is available (i.e., broadcast, on-demand) to the subscribers and allow the subscribers to select the content they wish to interact (i.e., view, record) with. The program guides can also organize the display of the content in a fashion that is suitable for the subscriber (i.e., list favorite programs, particular format). Program guides are often referred to as electronic program guides (EPG) or interactive program guides (IPG) and when used herein the term “EPG” will be meant to cover any and all program guides. EPGs also provide avails that usually consist of a portion of the screen being dedicated to an ad (i.e., static, video). According to one embodiment, the video ad may be the same as a programming ad (i.e., 30 second commercial) or may be the same as a VoD ad (i.e., infomercial, trailer).

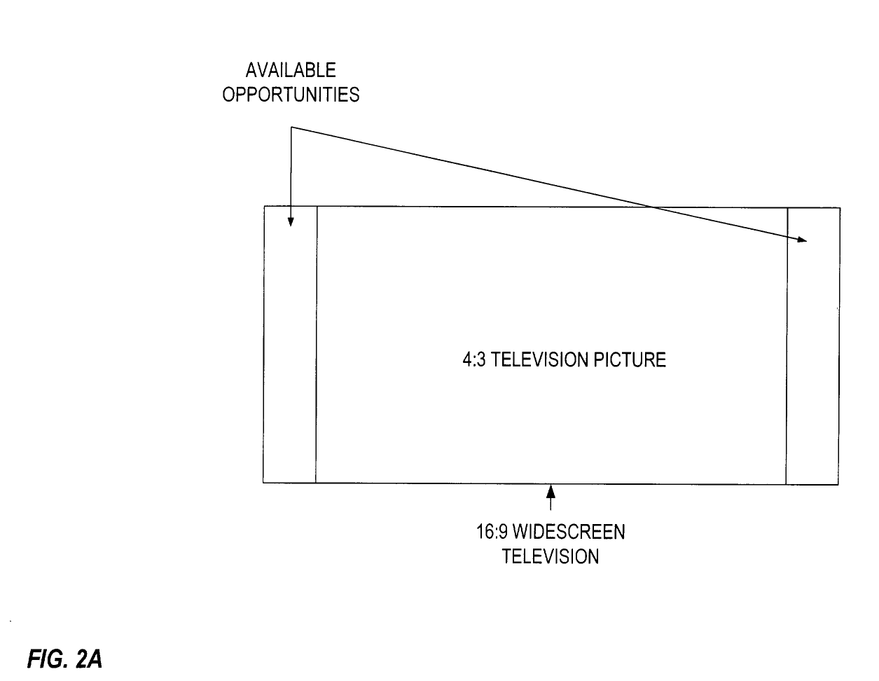

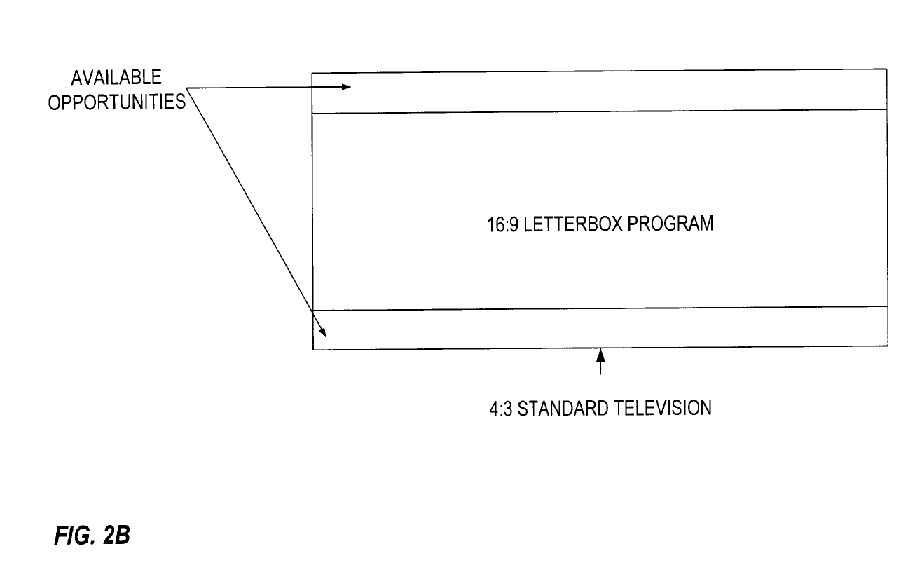

Moreover, additional advertisement opportunities exist when the type of programming and the display device are not in sync. For example, traditional broadcasting (4:3 resolution picture) viewed on a 16:9 resolution wide screen television does not use the entire screen (see FIG. 2A). Likewise, letterbox movies that are viewed on a standard 4:3 resolution television also do not use the entire screen (see FIG. 2B). The unused portion of the screens in each of these embodiments can contain targeted advertising, such as banner ads.

As should be apparent, advertisers and content providers have a multitude of avails that ads can be placed in. With such a myriad of options available, the advertiser may wish to place ads in one or more different avails and thus purchase the various avails. The different avails may be close together or overlap (i.e., product placement and bug at same time). Accordingly, it is possible to enhance an ad campaign by placing, in close proximity, ads for a specific product, service, or company in several different avail types. For example, a typical 30-second ad for Pepsi® may be followed by a product placement ad for Pepsi®. However, it is also possible that an advertiser may over saturate (and turn off) a subscriber by inundating the subscriber with ads for the same product, service or company an excessive number of times in a short period. For example, the programming has a bug, a product placement and an overlay for Coors light®, which is immediately followed by a commercial for Coors light®, which is immediately followed by an EPG ad for the same.

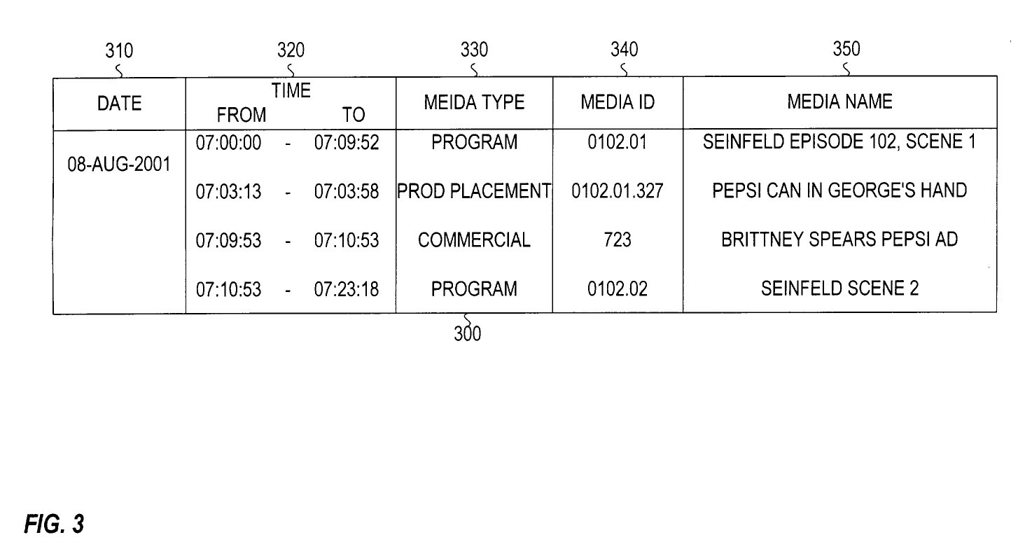

For each of the avail types defined above, there is likely some criteria (i.e., order) defining when the ads are displayed. For some of the avail types the criteria may be a playlist, which specifically defines which ad is played in which avail. This may be the case for the standard programming avails (i.e., commercial) as the exact locations of the avails are known and the advertisers pay for those specific avails (or at least avails within specific programs). A playlist may also be used for product placements and overlays as a specific ad needs to be generated to fit in the specific avail. Playlists may also be applicable for bugs as they can be inserted for specific programs (i.e., a Coke® bug may be displayed for the entire program or a portion thereof). FIG. 3 illustrates an exemplary playlist 300 identifying date 310, timeframe (to/from) 320, media type (i.e., program, ad) 330, media ID 340, and media name 350. As illustrated, this playlist 300 coordinates the placement of a product placement ad for Pepsi® (can in George's hand) with a Brittany Spears commercial for Pepsi®. As one of ordinary skill in the art would recognize, playlists are not limited to the above examples of avails and could be used for multiple different avails. Moreover, these avail types are not limited to being based on playlists. In fact, targeting advertising for these type of avails will be discussed in more detail later, including targeting programming avails (commercials) by utilizing an ad queue.

Other types of avails may define the order in which the ads are displayed by utilizing an ad queue that identifies a list of ads that should be played in a particular order as avails present themselves. Ad queues can be used when avails are always available (i.e., EPG ad window, bugs) and placement of ads in the avail continually changes based on time (i.e., every 30 seconds) or other factors (i.e., EPG screen, channel). One embodiment of an EPG, has avails defined at all times and accordingly has ads placed in the avails even if the EPG is not activated. Thus, the ads are constantly changing (i.e., every 30 seconds) according to the ad queue and when the subscriber activates the EPG they receive the ad that was in the avail at that point. Any subscriber that initiates the EPG (or a section of the EPG) at a certain time gets the same ads. Programming (at least for certain networks at certain times) may have continuous bug avails available. Each bug avail may have a certain duration (i.e., every 10 minutes) and network assigned so that each program receives a new bug every 10 minutes according to the queue. The bugs displayed in the programming (i.e., ESPN) will change for each subscriber viewing the programming regardless of how long they were watching the programming (i.e., ESPN). However, it is possible that the bug avails are not based on the network (channel) but are simply based on time, so that the next bug in the queue is displayed on all (or a portion) of the programming being delivered by the video delivery network for a certain time frame

Ad queues may also be used when the specific avails are not defined, as would be the case of an avail being created when a particular feature (i.e., EPG, record) is activated. For example, one embodiment of an EPG may select the next ad from the queue only when the EPG is activated (once an avail is defined for the specific subscriber). The first ad displayed when the EPG is activated is the first ad in the queue. After a predefined time frame (i.e., 30 seconds) the ads rotate through the EPG based on the queue. Thus, if the subscriber uses the EPG for more than 30 seconds the ad that is next in the queue will replace the first ad and so on. As one of ordinary skill in the art would recognize, ad queues are not limited to the above examples of avails and could be used for multiple different avail types. Moreover, these avail types are not limited to being based on ad queues (i.e., could be based on playlists).

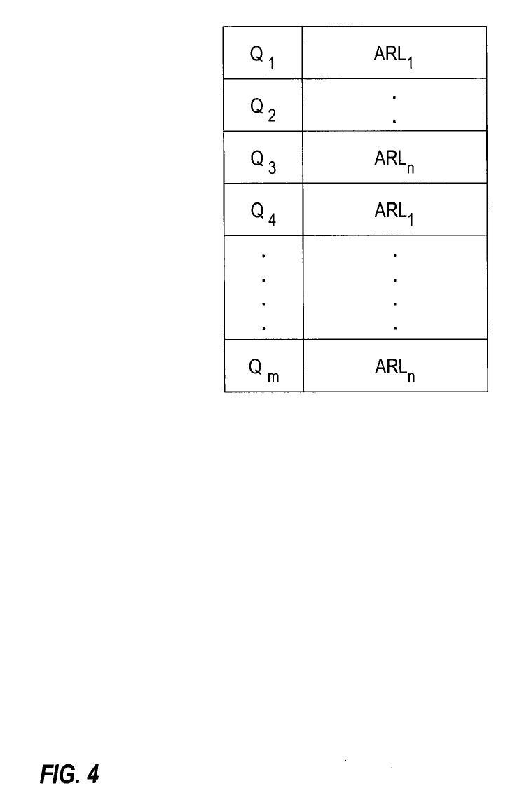

FIGS. 4-7 illustrate several different exemplary ad queues. Each of the exemplary ad queues is in the form of a matrix for simplicity of illustration and is not limited to such. As one skilled in the art would recognize the ad queue could take on many different forms without departing from the scope of the current invention. It is intended that each of the different forms that produce the same or similar result are within the scope of the current invention. As illustrated each of the exemplary ad queues has m slots in the queue (Q1-Qm). The location of each ad is identified by a pointer, known as an ad resource locator (ARL). The location of the ads may within the delivery network or may be maintained by the advertiser, a media buyer, a third party, or may be maintained by the subscriber, in the subscriber equipment (i.e., PVR or STB). The storage of ads locally will be discussed in more detail later. The queue is thus a stacked list of n ARLs (ARL1-ARLn).

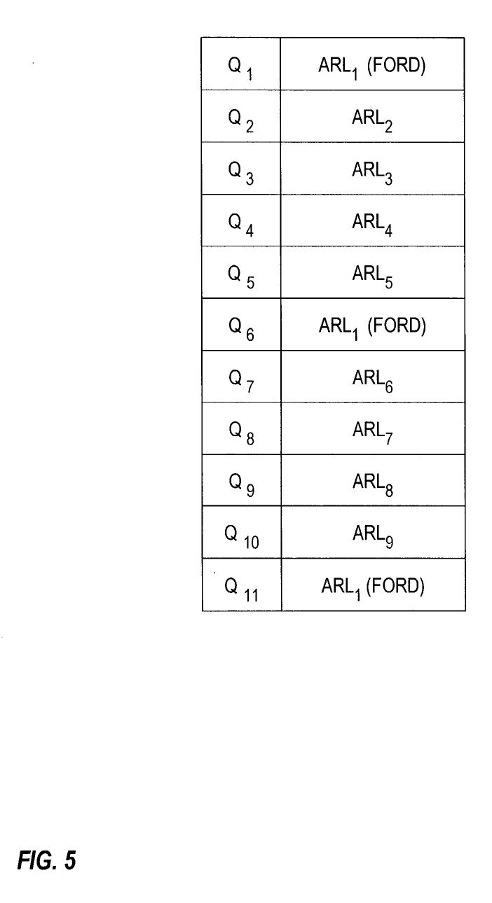

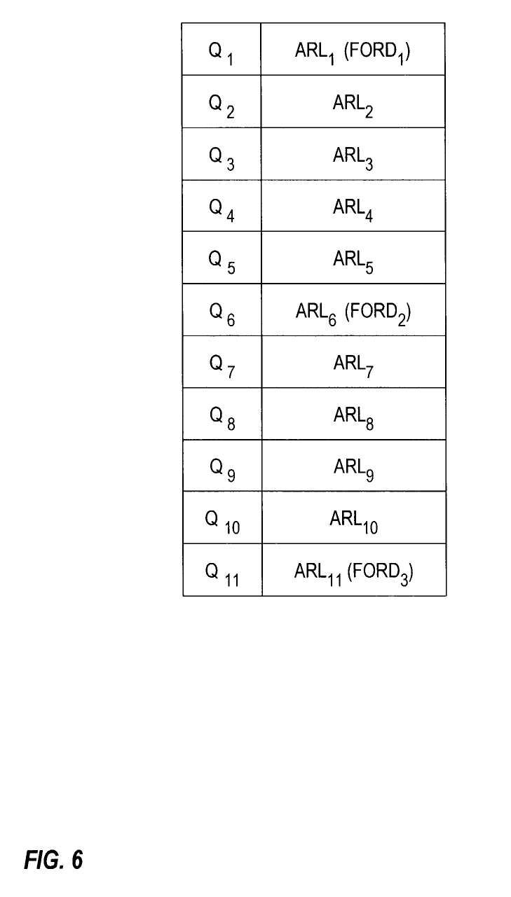

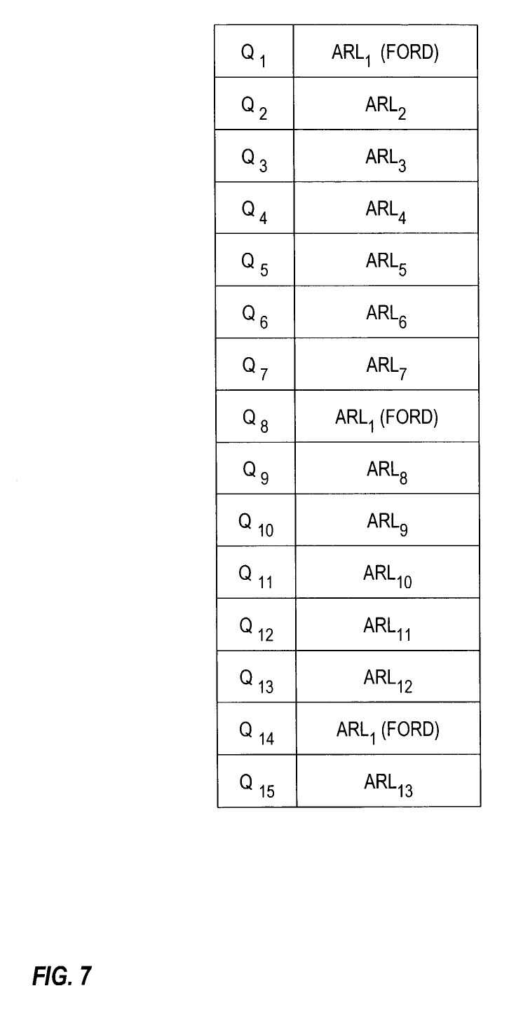

FIG. 4 illustrates an exemplary ad queue in which each of n ads is included two times. FIG. 5 illustrates an exemplary ad queue is which a certain ad is repeated. As illustrated, a Ford ad (located at ARL1) is repeated in the ad queue every fifth slot (Q1, Q6 and Q 11) so that Qnew=Qold+5. It should be noted that it is not necessary that every Ford ad be the same and, in fact, ads may be variants of an ad (such as a sequel or series of ads) so that the subscriber does not get bored by a particular ad. FIG. 6 illustrates such an exemplary case, wherein different Ford ads identified as ARL1, ARL6, and ARL11 are queued in slots Q1, Q6 and Q11, respectively. Furthermore, the ads in the queue may not be spaced evenly. For example, the spacing between ads may decrease with time (i.e., the repetition rate increases). An exemplary case is illustrated in FIG. 7, where the Ford ad (located at ARL1) is placed in the queue at slots Q1, Q8 and Q14. Thus, the initial spacing has 6 other ads between each Ford ad (i.e., a repetition rate of 1 Ford ad every 7 ads) and decreases to 5 other ads between each Ford ad (i.e., a repetition rate of 1 Ford ad every 6 ads).

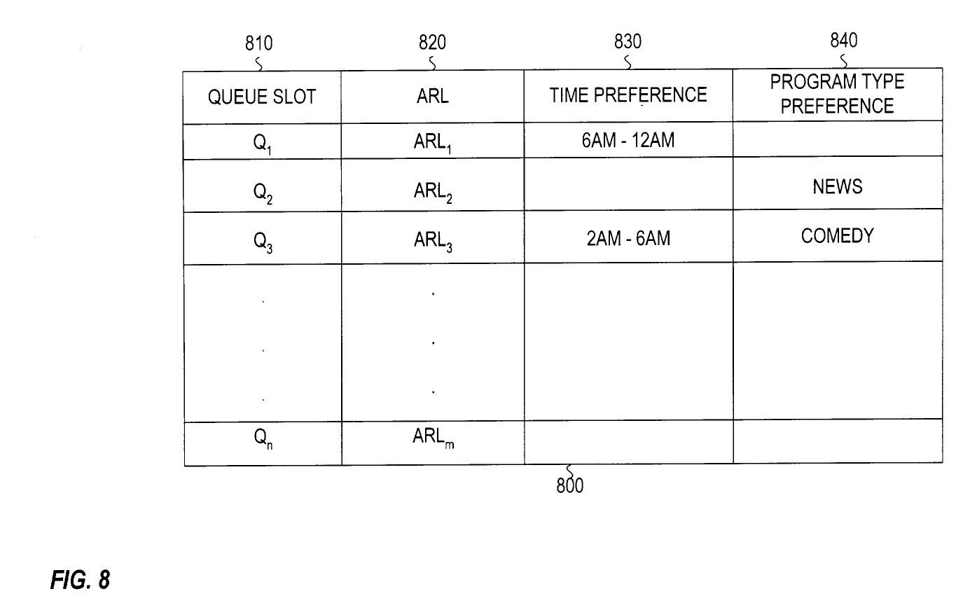

The ad queue need not be limited to a particular order. In fact, the ads may be stored in the queue based on time (i.e., month, week, day, hour), network, program or other criteria that would be obvious to those of ordinary skill in the art. FIG. 8 illustrates an exemplary ad queue that associates each ad (identified by ARL) 820 to a time of day preference 830 and a program type preference 840 as well as order as defined by the queue slot 810. As illustrated, the ad (ARL1) in Q1 has a preference for the time frame from 6 am-12 am but no preference for program type, the ad (ARL2) in Q2 has no preference for time but has a preference for the news, and the ad (ARL3) in Q3 has a preference for the time frame from 2 am-6 am and a preference for program type of comedy, while the ad (ARLm) in Qn has no preferences. The ads will be displayed based on the order of the queue as it is adjusted for any of the preferences. That is, the order of the queue is ARL1-ARLm when none of the preferences are present. However, if the news were on, ARL2 would be moved to the top of the queue since it has a preference for that type of programming and the remaining ads would stay in the queue based solely on order. Thus, the system has to be capable of monitoring time and then ordering the queue based on the time or selecting ads from the queue based on the criteria defined in the queue.

According to one embodiment the preferences could be weighted. For example, the weighting may be a numeric number that equates the importance of playing that particular ad at that particular instant (i.e., 0=no preference, 1=slight preference, 2=strong preference, 3 Patent must play). The preferences may also relate to not playing the ads during certain conditions (i.e., prefer not play during news, exclude playing during sporting events). The preferences may be weighted in such a fashion to take into account the play and not play preferences. For example, a numeric scale from 0-10 could be used where 0 represents “DON'T PLAY”, 10 represents “MUST PLAY”, 5 represents “No Preference”, from 1-4 represents varying degrees of desire not to play and 9-6 represent varying degrees of desire to play. The above ad queues are merely exemplary embodiments and are in no way intended to limit the scope of the current invention. There are numerous means for utilizing preferences in an ad queue and for weighting the preferences that would be obvious to one of ordinary skill in the art and would be well within the scope of the current invention.

Once the ads have been played from the top of the queue they may be added back to the queue, either at the bottom or some other location depending on the algorithm associated with the ad and the ad queue. The ad queue may also have limitations on the duration of time the ad is in the queue, the number of times the ad is played within a specific time (or other factor), the time frame between displaying the ads, or some other criteria now known or later discovered that would be obvious to one of ordinary skill in the art.

According to a preferred embodiment of the current invention, there is coordination amongst the various avail types, playlists, and ad queues. This coordination will be referred to herein as a “universal ad queue”. A universal ad queue may be:

a single ad queue that tracks each and all of the different avails for a content delivery system, the single ad queue may be

located at a single location, or

distributed amongst multiple locations;

multiple ad queues that are liked together in some fashion to coordinate the placement of ads in the various avails; or

other variations that would be known to those of ordinary skill in the art.

When used herein the term “universal ad queue” or UAQ is meant to describe each of the possible embodiments for coordinating the placement of ads for each of the various types of avails.

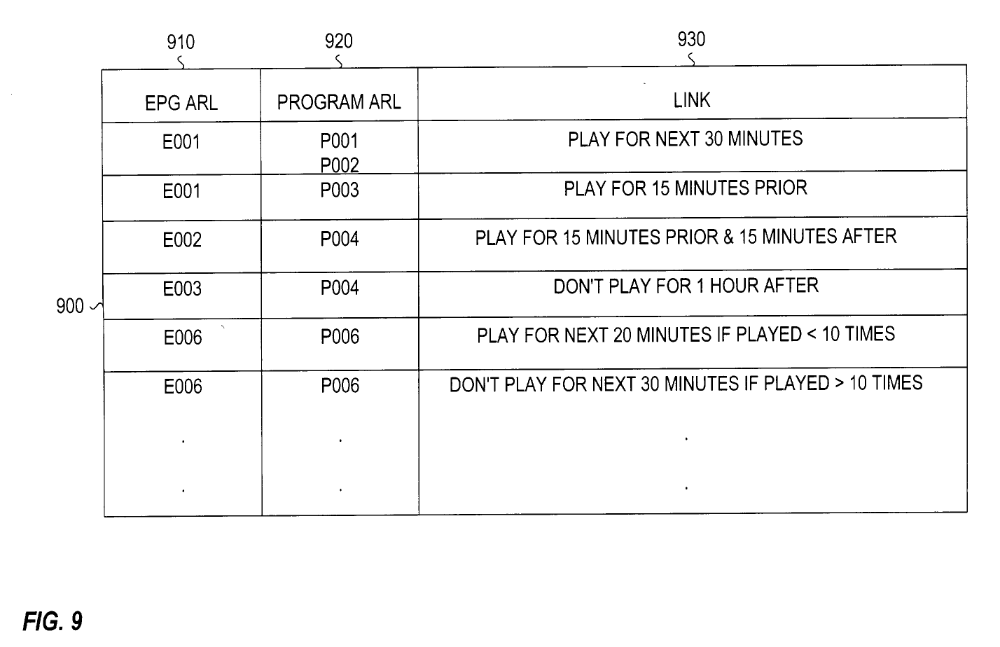

A first step for generating a UAQ is by forming some type of relationships between the different ad types. FIG. 9 illustrates an exemplary linkage table 900 between EPG ads and programming ads (commercials). As illustrated, the EPG ads are identified by EPG ARLs 910, and the programming ads are identified by programming ARLs 920. The linkage table 900 associates one to many EPG ARLs 910 with one to many programming ARLs 920. For example, E006 is linked to P006 (1 to 1), E001 is linked with P001-P003 (1 to many), and E002 and E003 are linked to P004 (many to 1). However, as should be obvious it is not necessary for each ARL (EPG or programming) to have a link to the other ARL (programming or EPG). The linkage type 930 defines how the ads are link to each other. The linkage may be a negative linkage, for example E003 should not be displayed in the EPG if the EPG is activated within 1 hour of P004 being displayed. The linkage may also be a positive linkage, such as E001 being displayed in the EPG if P003 was displayed in last 15 minutes. The linkage may be based on the programming ad having been displayed, the programming ad scheduled to be displayed (E001 to P003), or a combination thereof (E002 to P004). There may be more than 1 link defined between two ARLs. For example, as illustrated E006 and P006 are linked together as

(1) playing the EPG ad for the next 20 minutes after the programming ad was displayed if the programming ad has been played less than ten times (in say the last 4 hours) and

(2) not playing the ad for the next 30 minutes if the program ad was played more than 10 times.

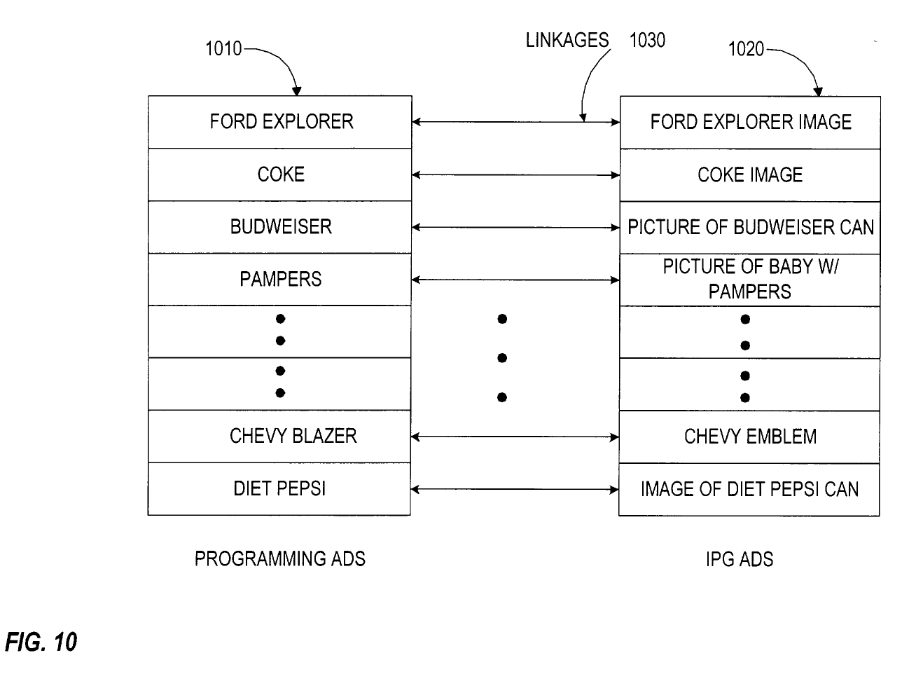

It should also be noted that just because two ads are linked together doesn't mean that the ads are the same. That is, the linkages can be very “tight” in the sense that the same product or service is advertised in both the avails (programming and EPG as illustrated), or could be relatively “loose” in that only ads for the same brand of product or category of product are linked between avails. FIG. 10 illustrates exemplary linkages between EPG ads and programming ads. An example of a tight linkage would be a programming ad for a FORD Explorer™ followed, by an EPG ad for a FORD Explorer™, though the ads would most likely be different. An example of a loose linkage is that of a programming ad for a particular Kraft™ cheese product followed by an EPG ad for Kraft™ in general, or a programming ad for Diet Coke™ followed by a panel ad for Coca Cola™ in the IPG. Moreover, advertisers could “partner” to deliver effective correlated ads. For instance, a programming ad for Budweiser™ could be followed (or preceded) by an ad for Hanover™ pretzels in the EPG, or an ad for “travel to the Bahamas” could be followed by an EPG ad for a particular hotel, airline, travel agent, etc.

The linkages between EPG ads and programming ads is not limited to those illustrated in FIGS. 9 and 10 as there are many other linkages that would be obvious to one of skill in the art that are well within the scope of the current invention. As will be evident to those skilled in the art, a wide variety of programming and EPG ad combinations and campaigns are possible ranging from extremely tight correlations to extremely loose correlations. The degree of correlations between the programming and EPG ads can be chosen or set depending on a multitude of factors, including pricing and timing, and by a variety of participants including, but not limited to, the advertiser, the content provider, and the subscriber. Moreover, the linkages are not limited to EPG and programming ads, but can be applied to any of the different type of ads without departing from the scope of the current invention (i.e., EPG to bugs, bugs to programming).

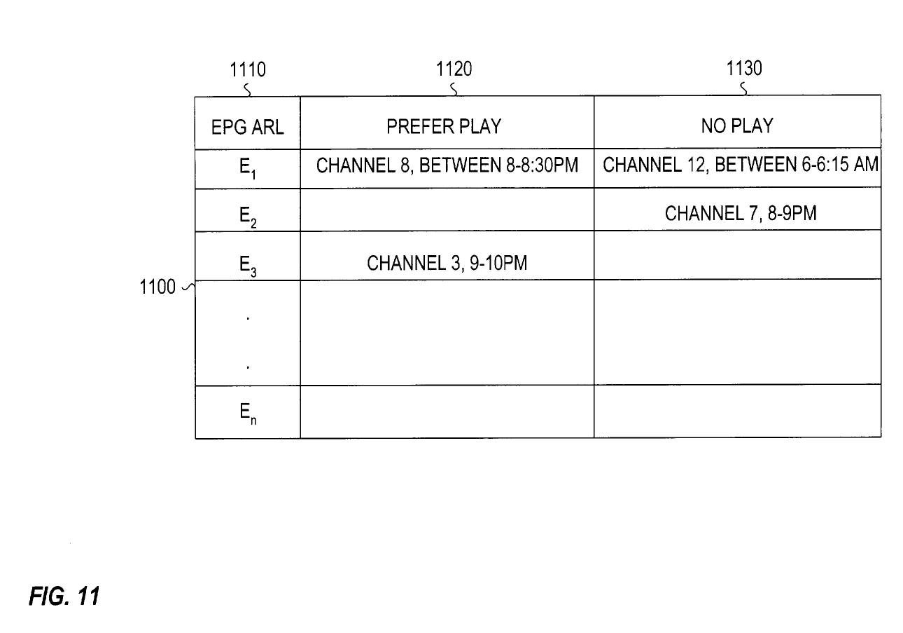

According to one embodiment, the ads in the programming are predefined in a playlist (i.e., the time or at least relative time is known). After the linkages between ads have been identified, it is possible to generate a UAQ based on the defined links and playlist. FIG. 11 illustrates an exemplary embodiment of an UAQ 1100 that coordinates the display of EPG ads with programming ads. As illustrated the UAQ 1100 includes the EPG ARL 1110, a preferred play 1120 description, and a no play 1130 description. These descriptions define when that particular EPG ad is preferred to be played or should not be played based on the linkages between the EPG ads and the programming ads and the schedule for when the programming ads will be displayed. As illustrated, EPG ad E1 should preferably be displayed in the EPG if the EPG is activated while the subscriber is viewing channel 8 between 8-8:30 but should not be displayed if the EPG was activated while the subscriber was watching channel 12 between 6-6:15. As should be obvious to one of ordinary skill in the art, the ads are taken from the queue out of order (or the order is modified) based on the channel and time and whether any of the EPG ads have preferences or blocks associated with those criteria.

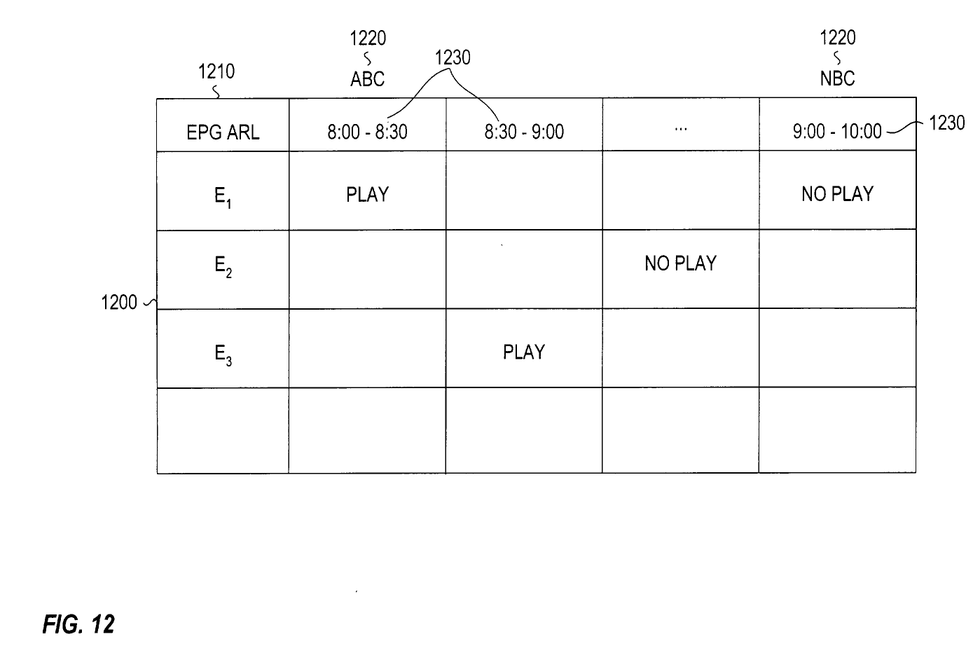

FIG. 12 illustrates an alternative exemplary embodiment of an UAQ 1200 that coordinates the display of EPG ads with programming ads. As illustrated, the UAQ 1200 includes the EPG ARL 1210, and columns for each network 1220 and daypart 1230. As illustrated the dayparts 1230 are not necessarily the same for each network. At the cross section of the EPG ARL 1210 and the network/daypart 1220/1230 (each cell of the matrix) special instructions (preferences/avoids) are defined. The EPG ads are inserted in the order they are in the queue unless: a preference (i.e., E3 if ABC between 8:30-9) moves an ad up in the queue, or an avoid (i.e., E1 if NBC between 9-10) skips an ad in the queue.

The exemplary embodiments of FIGS. 11 and 12 are not intended to limit the scope of the invention. Rather as one of ordinary skill in the art would recognize, the UAQ can be organized in multiple fashions, or be any size or structure without departing from the scope of the current invention. There can be any type of ads or combination of ads in the queue, the ads in the queue may be linked to other ads, other events, time or other criteria. The UAQ is not limited to a matrix as illustrated in the exemplary embodiments (FIGS. 11 and 12). The UAQ can be numerous other functional equivalents (i.e., a database), all of which are all well within the scope of one of ordinary skill in the art, without departing from the scope of the invention.

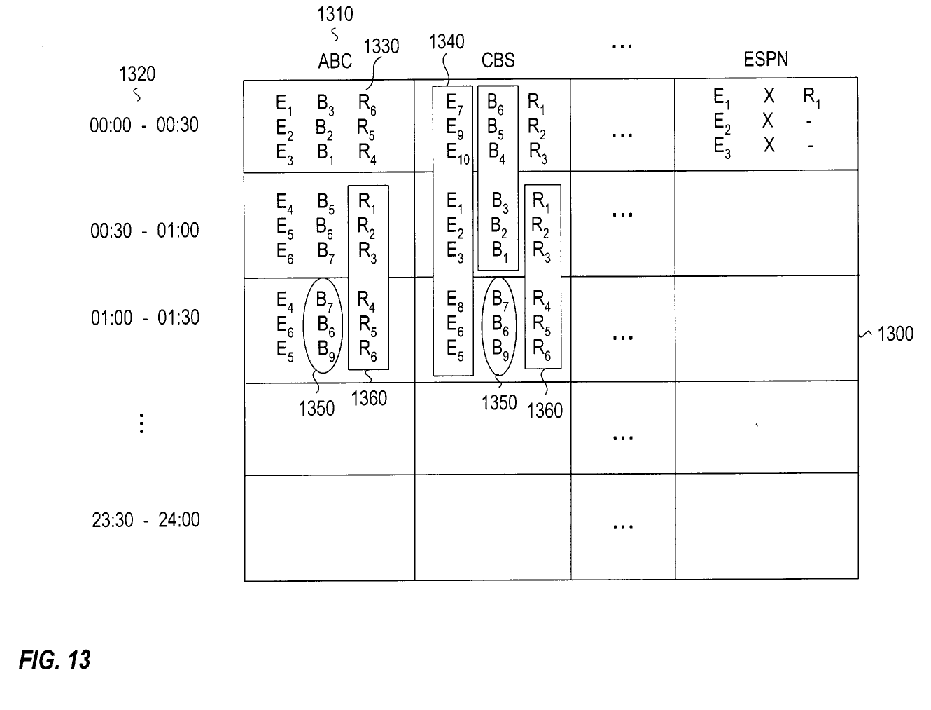

FIG. 13 illustrates another exemplary embodiment of a UAQ 1300 that defines separate queues based on network 1310 and day part 1320. Within each network/daypart intersection (cell) 1330 there are three separate queues defined. There is a queue for EPG ads (Ex), bug ads (By) and product placement ads (PPz). As illustrated each ad type queue is not linked to each other type of ad queue, but the invention is in no way limited thereto as the individual queues could be linked to each other in any number of ways (i.e., Ex to By and PPz, By to Ax, PPz to By). Each set of ad queues may be applicable to a single cell (as soon as the network or day part is changed a new queue is selected) or the ad queues may extend across networks, day parts or both. The ABC 00:00-00:30 cell is an example of a single cell ad queue as if you proceed to the next time frame or network the queues are reset. Thus, it doesn't matter how many of the ads from queue in the ABC 00:00-00:30 cell were displayed, if the network or day part is changed the queue will be switched to the queue associated with the next network or day part. An example of a multi day part ad queue 1340 is the Ex ad queue that extends through the CBS 00:00-00:30, 00:30-01:00, and 01:00-01:30 cells and the By ad queue that extends through the CBS 00:00-00:30 and 00:30-01:00 cells. For these multi day-part ad queues 1340, the ads are played in the order of the overall queue, meaning that if the first time the EPG was activated was between 01:00-01:30 the first ad from the queue (E7) would be displayed.

An example of a multi-network ad queue 1350 is the By ad queue that extends across the ABC and CBS cells. For this multi-network ad queue 1350 if the B7 bug ad was displayed during ABC programming and then the channel was switched to CBS, the first bug ad displayed on CBS would be B6. An example of a multi-network/multi-day part ad queue is the PPz ad queue that extends across ABC and CBS networks and 00:30-01:00 and 01:00-01:30 dayparts. The ads would be displayed in the order of the queue (PP1-PP6) regardless of the daypart or network. Also illustrated, a By ad queue instructs no bug ads to be displayed on ESPN from 00:00-00:30 (represented by the Xs). In that same cell, the PPz queue lists a first product placement ad to be displayed and then does not specify any other ads (meaning that a generic ad queue can be used as there is no other preference for that cell). It should be noted that FIG. 13 is simply an exemplary UAQ displaying multiple different ad queues for different network/day part combinations and is in no way intended to limit the scope of the invention. There are numerous other types of UAQs that would fall within the scope of the current invention.

According to one embodiment, the UAQ is generated within the content delivery system, by a network operator, a third party, or other individuals/groups that would be obvious to those skilled in the art. These individuals may use an ad management system, a traffic and billing system, or other now know or later discovered systems that are known to those skilled in the art to assist in the generation of the UAQ (hereinafter will be referred to as UAQ generation systems). These UAQ generation systems may be implemented as a set of computer instructions stored on a computer readable medium (software programs) that are developed using any number of different languages, operating systems or platforms. As one of ordinary skill in the art would recognize, the programming languages include C, C++, Perl, and Java, although the scope of the invention is not limited by the choice of a particular programming language or tool. Object oriented languages have several advantages in terms of construction of the software used to realize the present invention, although the present invention can be realized in procedural or other types of programming languages known to those skilled in the art.

The data used to generate the UAQ is likely obtained from the advertisers, media buyers, the product/service providers directly, or other third parties involved in the advertising process (hereinafter simply referred to as advertiser). The UAQ generation systems may provide the advertiser with a user interface that allows them to define their ad campaign (i.e., select the ad avails that they would like to place ads in). The UAQ systems may also be capable of excepting this data into the system via other means that include, but are not limited to, phone, mail, email, file transfer, and a combination thereof. As would be obvious to one of skill in the art, the selection of avails may be specific (i.e., the second avail in the Friends program aired on Feb. 25th, 2002) or may be general (i.e., 3 spots placed somewhere in prime time programming the week of Mar. 1st, 2001). The selection of avails may define an exact mix of avail types (i.e., 3 program ads, 17 EPG ads, 6 bugs), a range of avail types (i.e., 1 to 2 program ads, 14 to 17 bugs), simply define acceptable avails (i.e., only EPG and bugs), or simply define an overall criteria (i.e., total of 40 avails, total budget of $20,000). The advertiser may also define links between different types of avails and the associated ads (described above).

The UAQ generation systems take the data from each of the advertisers and generates the UAQ based thereon. As previously noted, the ads to be played in the avails are in the form of playlists (i.e., programming ads) or specific ad queues (i.e., EPG ads). The UAQ links the display of the ads in the playlists and the display of the ads in the queues. Thus the UAQ enhances the advertising campaign. For example, the UAQ will ensure that the ad campaign may emphasize the ad message by playing related ads together in different formats (avails) in a relatively short time. The UAQ may be generated at fixed intervals of time (i.e., weekly, monthly), when required (i.e., no ads in queue), other ways that would be obvious to those of ordinary skill in the art, or some combination thereof. According to one embodiment, the entire UAQ is generated every time programming playlists (including programming ads) are generated and the UAQ is updated each time an individual ad queue needs to be updated because it is out of ads (i.e., played maximum number of times, ad campaign over, new advertisers have purchased avails, existing advertisers have opted out of their avails, or any other number of reasons that would be obvious).

The UAQ must be maintained based on ads displayed and avails presented. For example, the UAQ may reorder the ads in a particular ad queue (or a combination of ad queues, or all the ad queues) based on what ads were displayed for a particular avail from a particular ad queue. Moreover, the UAQ must be aware of what time it is and what channel is being viewed so the UAQ can select the appropriate ads therefrom. The UAQ may be maintained by the video delivery system (i.e., headend), the subscriber (i.e., STB), or some combination thereof.

According to one embodiment, the UAQ is maintained in its entirety by the video delivery system. That is, the video delivery system uses the UAQ to determine what ads (for all types of ads) the subscriber will see next. For this embodiment, it is necessary that the video delivery system know at least some information about what the subscriber is watching so that the system can identify the avail (i.e., bug) or know what ad queue to select from when the avail presents itself (i.e., EPG). In order for the video delivery to know this data there would have to be a feedback path with the subscriber end (i.e., STB). The feedback is inherent in a Switched Digital Video (SDV) system as the channel changes are processed at the headend so that the system could identify avails in the currently watched programming (i.e., bugs) and would know what ad queue to select from when avails presented themselves (i.e., EPGs). According to one non-SDV embodiment, the STB can communicate the necessary information (i.e., channel being viewed) to the headend when the avail (i.e., EPG) becomes available. The video delivery system then selects the ad, from the appropriate ad queue, to be displayed to the subscriber.

According to one embodiment, the UAQ is maintained by the subscriber. For this embodiment, the UAQ is transmitted to the STB (PVR or other similar device) and stored thereon. The STB keeps track of the ads displayed to the subscriber, the channels viewed, the time and the other necessary information for the appropriate ads to be selected from the UAQ for the associated avails. The STB either transmits the selection data to the delivery network, or inserts the ads in the avails locally at the STB (local insertion discussed in more detail later). According to one embodiment, a portion of the UAQ is maintained by the video delivery system (i.e., program ads, product placement ads) and a portion of the UAQ is maintained by the STB (i.e., EPG ads).

Regardless of where the UAQ is stored and maintained, the ads that are to be displayed based on the UAQ may be stored by the video delivery network, by the subscriber, by the advertisers, a media buyer, the individual product/service companies, or a third party. If the ads are stored by the delivery network (or in fact if they are stored anywhere except at the STB), the delivery network (headend) retrieves the ads, inserts the ads in the avails, and delivers the programming with the ads inserted therein to the STB. According to one embodiment, the programming ads would be inserted in the avails according to the playlist. In fact, it is likely that the programming ads would be included in the broadcast from the network and that the video delivery system (headend) would just transmit the programming and ads at the appropriate time. However, as one skilled in the art would recognize the headend would likely have the right to substitute a portion (i.e., 20%) of the national programming ads with local ads. According to one embodiment, the insertion of the local ads would follow the playlist. According to an alternative embodiment, the insertion of the local programming ads may be done in accordance with an ad queue that lists an order for the programming ads to be inserted in. As would be obvious to one of ordinary skill in the art, the ad queue may change based on different factors that include but are not limited to day, time, and program. Regardless of how the local ads are selected, the local ads would be retrieved from storage (whether it is within the headend or maintained by an external party) and inserted in the programming, and the programming and local ads would then be delivered to the subscriber.

According to one embodiment, the product placement, overlays, and bug ads are treated just like the programming ads in that they may be included in the programming broadcast from the network or that they may be inserted at the headend according to a playlist or an ad queue which are part of (or are related/linked to) the UAQ. As would be obvious to one of ordinary skill in the art, product placement and overlay ads are specific to the individual avail and as such the selection of ads to place in these avails is limited. Thus, if an ad queue were used to determine the ads to be inserted (at the headend) in these types of avails, the ad queues would be relatively small (i.e., limited number of options). Regardless of how these ads (product placement, overlays) are selected, the delivery system would retrieve the ads from storage (whether it is within the headend or maintained by an external party), insert the ads in the programming, and deliver the programming with ads inserted therein to the subscriber.

As bugs are simply images overlaid on a portion of the screen, ad queues can be used with an almost unlimited number of ads (and preferences associated therewith) for insertion at the headend. The headend can select the next bug ad in the queue taking into account the viewing circumstances (any potential preferences). Regardless of how bugs are selected, the delivery system retrieves the bugs from storage, inserts them in the programming, and delivers the programming with bugs to the subscriber. The insertion of ads at the headend is disclosed in more detail in Applicants co-pending patent applications previously incorporated in its entirety by reference (but not admitted to be prior art) and identified by docket numbers T712-10 and T721-10PCT.

For EPGs, it is likely that at least a portion of the EPG is stored within the STB (i.e., downloaded every night). When the subscriber activates the EPG, the EPG is generated at the STB based on at least the portion of EPG data that is available at the STB. According to one embodiment, part of the EPG data that is downloaded to the STB may be the ad queue. The ARLs in the ad queue may point to the content delivery network (or other storage location that is external to the subscribers residence). The content delivery network thus retrieves the ads and sends the ads to the STB for insertion into the EPG avails. The ads may be sent via the delivery network (i.e., an ad channel) or via a separate connection (i.e., Internet). According to another embodiment, each time an ad is identified by the ad queue it is retrieved from storage and transmitted to the STB regardless of whether the EPG is activated or not. The STB may maintain the ad locally for the duration of the associated avail so that the ad can be inserted in the EPG if the EPG is activated during that avail. According to another embodiment, the STB may inform the delivery network when the EPG is activated and the delivery network may retrieve the appropriate ad(s) from the ad queue, insert the ads in the EPG, and then deliver the EPG with ads to the STB.

If the ads are stored at the STB, the ads are inserted in the programming at the STB. It should be noted that inserting ads at the STB is likely not capable of being accomplished (at least on a large scale) until STBs come equipped with a large amount of memory. STBs with memory are often referred to as PVRs. PVRs and there effect on the advertising in general and specifically as it relates to the UAQ will be discussed in greater detail later. However, a brief description of ad insertion at the STB is discussed below.

If the UAQ is fully maintained by the delivery network, the delivery network needs to send the STB instructions as to which ads to insert when (and potentially where in the case of product placement, overlays and bugs). The instructions may be associated with the programming the ads are to be inserted in, the channel, the time, the activation of a feature (i.e., EPG) or other criteria that would be known to those skilled in the art. The instructions may be transmitted at fixed intervals (i.e., every night, every 4 hours), with applicable programming, when required, or some combination thereof. The instructions may be received:

at the time (or approximate time) of the applicable avail so that the instructions can be immediately processed (on-the-fly) and need not be stored (may be temporarily stored in flash memory) by the STB; or in advance of the associated avail so that the instructions are stored at the STB and then matched and processed at the time of the avail.

The instructions may be simple (i.e., insert ADI now) or complex (i.e., insert the first three ads in EPG queue 1 if the EPG is activated prior to 9:00, the 2nd-4th ads from EPG queue 2 if it is after 9:00 and CBS is tuned to, and the first three ads from EPG queue 3 if it is after 9:00 and any station but CS is tuned to). The instructions may be transmitted to the STB along with the programming (as meta data), on a separate channel (instruction channel or as part of the ad channel), or via a separate connection (i.e., Internet).

If the instructions are transmitted along with the programming, the metadata may be attached/embedded in the programming or linked thereto. The metadata may be packaged in a proprietary format or use an existing (or developing) international or industry standard. A proprietary format would be defined as a structure or string of text and/or numeric characters. An international standard for audiovisual metadata, such as the ISO/IEC “Multimedia Content Description Interface” (also know as MPEG7) or the TV-Anytime Forum “Specification Series: S-3 on Metadata”, could also be used to provide the format for the instructions. The use of an international standard would facilitate the use of widely available software and equipment for the insertion of instructions to the audiovisual content. The metadata can be transported using methods including but not limited to:

as an “Extended Data Service” (XDS) as defined in the Electronic Industries Association's Recommended Practice: EIA-608 on line 21 of an analog video signal (often referred to as the vertical blanking interval (VBI));

as MPEG-2 video “user_data”, as defined in ISO/IEC 13818-2;

as a separate, but associated, MPEG-2 Systems data “PID” as defined in ISO/IEC 13818-1; or

as a sequence of IP (Internet Protocol) packets traveling over the same or different path as the audiovisual content.

The meta data can be linked and synchronized with the appropriate content by using the standard synchronization services provided by the MPEG standard or by an alternative “System Clock Reference” carried by both the content and the meta data. The transportation of metadata (i.e., instructions) is described in detail in Applicant's co-pending application that has previously been incorporated by reference in its entirety (but not admitted to be prior art) and identified by docket number T720-00.

As one skilled in the art would recognize, if the ads are stored at the STB but the UAQ is maintained by the headend and accordingly the instructions are received from the headend, the delivery network needs to have some knowledge of the viewer's interactions with the TV so as to provide accurate instructions. As previously mentioned, this feedback is inherent in an SDV environment. For non-SDV environments, the STB must report at least some data related to viewing interactions to the headend. In a preferred embodiment, the interaction feedback will not disclose any confidential information and the information that is disclosed will be privacy protected in some form (no personal information used to identify you).

In addition to the ads being stored at the STB, a portion of (or potentially all of) the UAQ may also be stored and maintained at the STB. As the STB would be aware of the subscribers' interactions with the TV, the STB would retrieve and insert the appropriate ads based on the UAQ. The STB may receive additional ads or an updated ad queue at fixed intervals of time. Alternatively the STB would request additional ads and/or an updated UAQ when these were required.

The need for a UAQ has been defined up to this point with respect to standard ad campaigns (no targeting) that utilize the multitude of advertising opportunities available. However, targeting advertising provides advertisers with an ability to target ads to those subscribers most interested in the products/services being advertised. Moreover, targeted advertising provides network operators with additional revenue streams as they may sell the same avail to multiple advertisers with each advertiser paying a premium for the subscribers they are targeting (i.e., charge each of two advertisers $60K for delivering ads to 50K subscribers ($1.20/sub) instead of charging a single advertiser $100K for delivering an ad to all 100K subs ($1.00/sub)). Ads can be targeted to groups, individuals, or a combination thereof. The groups may consist of all subscribers connected to a node, cluster of nodes, branch, or cluster of branches; or all subscribers having similar traits, or some combination thereof. The ads can be targeted based on demographics, viewing habits, purchasing habits, interests, other characteristics, or some combination thereof. As should be obvious, targeting advertising increases advertising opportunities and accordingly increases the need for the UAQ as the number of potential ads available for placements and the coordination necessary grows exponentially.

While it is possible to specifically target different ads to each subscriber (or even each individual), there is probably a point at which the benefit of that targeting is outweighed by the cost associated with targeting to that level. Thus, there is a limit to how specifically targeted ads can be. According to one embodiment, the subscriber base is divided into a specific number of types (i.e., 5) and the ads are targeted to those different subscriber types. According to an alternative embodiment, a specific number of ad types (representing intended target markets) are identified and the subscriber base is partitioned such that each subscriber (or group of subscribers) is associated with one of these ad types by correlating subscriber traits with the intended target market traits. The subscriber and ad types may be based on demographics, transaction characteristics, interests, other known criteria, or some combination thereof.

According to one embodiment, the assignment of subscribers to groups (whether based on ad type of subscriber type) is performed by correlating demographic data provided by third parties, such as by MicroVision, a product of Claritas, Inc. of San Diego, Calif. that provides demographic segment statistical information for market segments defined by ZIP+4 (approx. 10-15 households). The groups are formed by correlating each segment with an ad type or with each other segment and including each segment with the ad type or other segments that it is most similar to. If the correct number of groups are not formed or if the groups do not include enough subscribers, the correlation thresholds may be changed or groups may be combined if they are similar to each other. The generation of groups based on demographics is defined in more detail in applicants' co-pending patent applications that have previously been incorporated by reference (but not admitted to be prior art) and identified by docket numbers T719-00, T741-10 and T741-10PCT.

According to another embodiment, the groups may be generated by grouping subscribers having similar viewing characteristics. The viewing characteristics are generated by monitoring subscriber interactions with the TV and processing the interaction transactions in order to identify specific traits associated with the subscriber. The viewing characteristics may include, but are not limited to, favorite channels, favorite genre, channel change rate, and dwell time. The characteristics may be broken out by day and day part. It should be noted that the viewer characterizations include no raw transaction data. The groups are formed by correlating each subscriber's viewing characteristics with either (1) an ad type defining viewing characteristics of an intended target market, or (2) with each other subscribers viewing characteristics. Each subscribers viewing characteristics is included with the ad type or other subscribers viewing characteristics that it is most similar to. The generation of viewing characteristics is defined in more detail in Applicants co-pending applications that have previously been incorporated by reference in their entirety (but not admitted to be prior art) and identified by docket numbers T702-00, T702-02, T702-04, T702-15, T703-00, T704-00, T704-01, T704-01PCT, T734-10, T741-10 and T741-10PCT.

According to another embodiment, the groups may be generated by grouping subscribers having similar transaction characteristics. The transaction characteristics are generated by monitoring subscriber transactions and processing the transactions in order to identify specific traits. The transactions may include purchasing transactions, Internet surfing transactions, location transactions or other transactions that could be monitored and processed. It should be noted that the subscriber characterizations include no raw transaction data. The groups are formed by correlating transaction characteristics with other transaction characteristics or with ad types identifying transaction characteristics. The generation of different transaction characteristics is defined in more detail in Applicants co-pending applications that have previously been incorporated by reference in their entirety (but not admitted to be prior art) and identified by docket numbers T706-11, T741-10, T741-10PCT and Applicants U.S. Pat. No. 6,298,248 (docket number T706-00).

According to another embodiment, the groups may be generated by grouping subscribers having similar interests. The interests are generated by applying heuristic rules to at least some combination of the viewing characteristics and the transaction characteristics. The interests may be probabilistic in nature. The interests may include, but are not limited, to product preferences, program preferences, hobbies, travel preferences, and music preferences. The generation of interests by applying rules to transactions is disclosed in more detail in Applicants co-pending applications that have previously been incorporated by reference in their entirety (but not admitted to be prior art) and identified by docket numbers T702-00, T702-02, T702-04, T702-15, T703-00, T704-00, T704-01, T704-01PCT, T706-11, T734-10, T741-10,T741-10PCT and

Applicants U.S. Pat. No. 6,298,248 (docket number T706-00).

According to another embodiment, the subscribers may be grouped based on some combination of the above defined embodiments. For example, the groups may be formed on a combination of demographics and viewing characteristics. It should be noted that the demographics associated with the subscribers are not limited to the demographics (market segments) retrieved from third party databases. Rather, the subscriber demographics may be derived by applying heuristic rules to the transaction characteristics (i.e., viewing, purchasing, some combination of transactions). The derived demographics may be probabilistic in nature. According to one embodiment, the demographics are based on a combination of the data provide by the third party database and that deriver by applying rules within the system. The generation of demographics by applying rules to transactions is disclosed in more detail in Applicants co-pending applications that have previously been incorporated by reference in their entirety (but not admitted to be prior art) and identified by docket numbers T702-00, T702-02, T702-04, T702-15, T703-00, T704-00, T704-01, T704-01PCT, T706-11, T734-10, T741-10, T741-10PCT and Applicants U.S. Pat. No. 6,298,248 (docket number T706-00).

Once the groups are formed the ads can be selected to target to the groups. The targeted ads are those whose intended target market is highly correlated with the traits associated with the group. According to one embodiment, the ads are targeted from the headend. The headend selects targeted ads that match each of the groups and inserts the targeted ads in the programming to create presentation streams. The ads inserted in the programming may include programming ads, product placements, overlays, bugs, or a combination thereof. Each type of ad inserted in the programming may be targeted or only a subset of the ads may be targeted. The presentation streams are then transmitted to the appropriate groups.

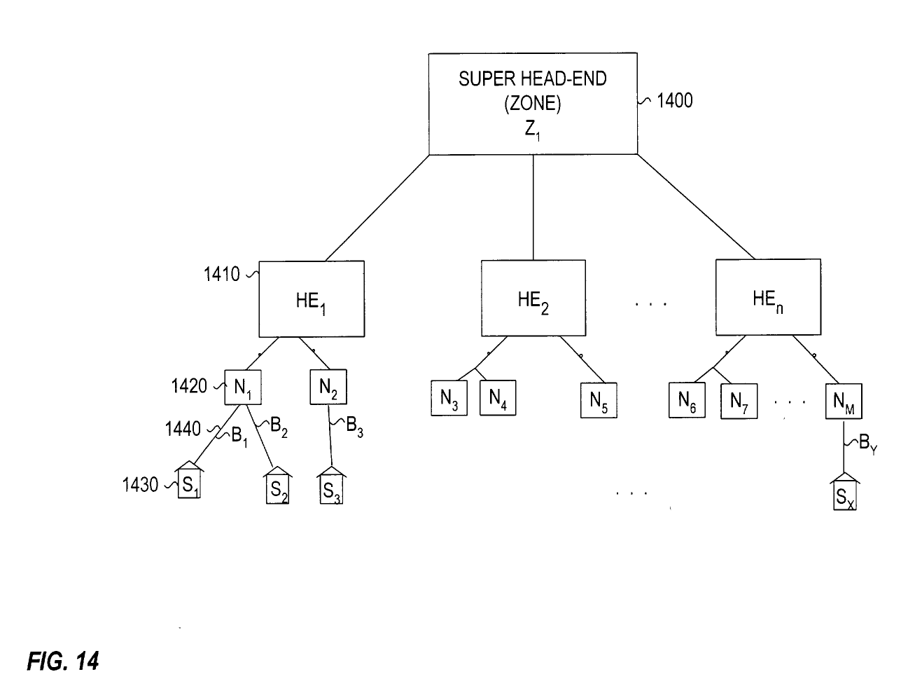

According to one embodiment, the groups may be formed based on the layout of a video delivery system (i.e., CTV plant). As illustrated in FIG. 14, a typical CTV plant can be viewed hierarchically. A zone or super head-end (Z1) 1400 receives national programming via satellite or other means from content providers and distributes the national programming to a plurality of head-ends (HE1 . . . HEn). Each HE serves a number of nodes. As illustrated, a fiber optic cable connects the HE to a single node (i.e., HE1 to N1) or a group of nodes (HE2 to N3 and N4). When the term node is used hereinafter it may reflect a single node or a group of nodes (node group) that are connected to a HE 1410 via a fiber optic cable. Each node 1420 serves a plurality of subscribers 1430 via a plurality of branches 1440 from each node 1420. The number of subscribers 1430 varies for different systems, but generally each node 1420 serves 150 to 750 subscribers 1430.

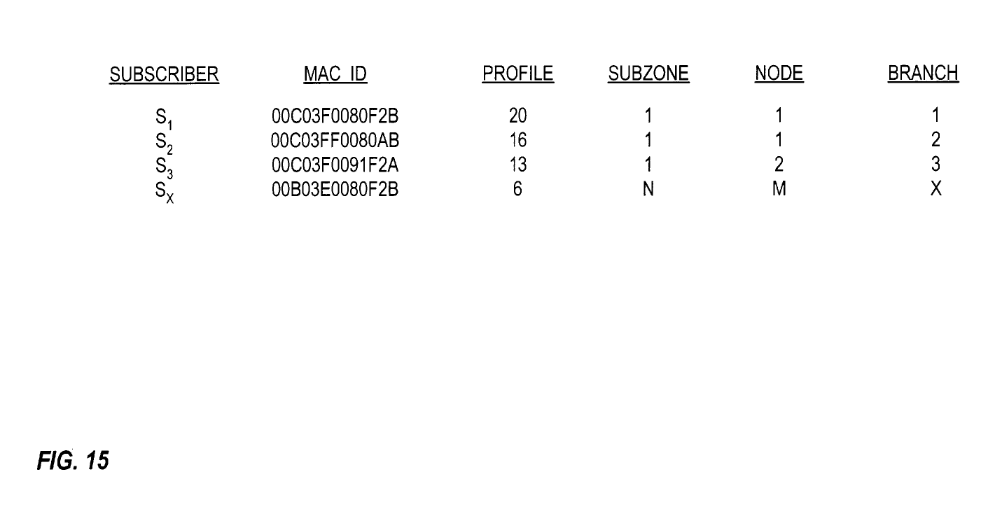

The subscribers 1430 may be grouped by head-end (subzone) 1410, node (microzone) 1420 or branch 1440. Regardless of how the subscribers 1430 are grouped it is necessary for there to be a correlation between each subscriber 1430, their respective profile, and each headend 1410, node 1420 or branch 1440 respectively. FIG. 15 illustrates an exemplary table correlating subscribers S1-S4 of FIG. 14, with their MAC-ID, a profile (may be a segment profile as defined by Claritas or other profile type defined above), and the subzone (head-end) 1400, node (microzone) 1420, and branch 1440 that are connected to within the CTV system. As illustrated, if groups were formed based on the subzone subscribers S1-S3 would be in one group while subscriber Sx would be in another group. If groups were formed based on node, subscribers S1 and S2 would be in a first group, subscriber S3 would be in a second group and subscriber Sx would be in a third group. If groups were formed based on branch, each subscriber S1-Sx would be in there own group.

If the subscribers are grouped by headend (subzone), node (microzone), or branch an average profile may be generated for subscribers within the subzone (subzone profile), microzone (microzone profile) or branch (branch profile) respectively. The subzone, microzone, and branch profiles may simply be an average of the profiles for each household within the subzone, microzone or branch or it may be a weighted average based on the number of subscribers within each household. As one skilled in the art would recognize, there are numerous methods for generating the subzone, microzone or branch profiles that would be well within the scope of the current invention. Ads may be targeted to the subscribers within the subzone, microzone or branch based on the subzone, microzone or branch profile respectively.

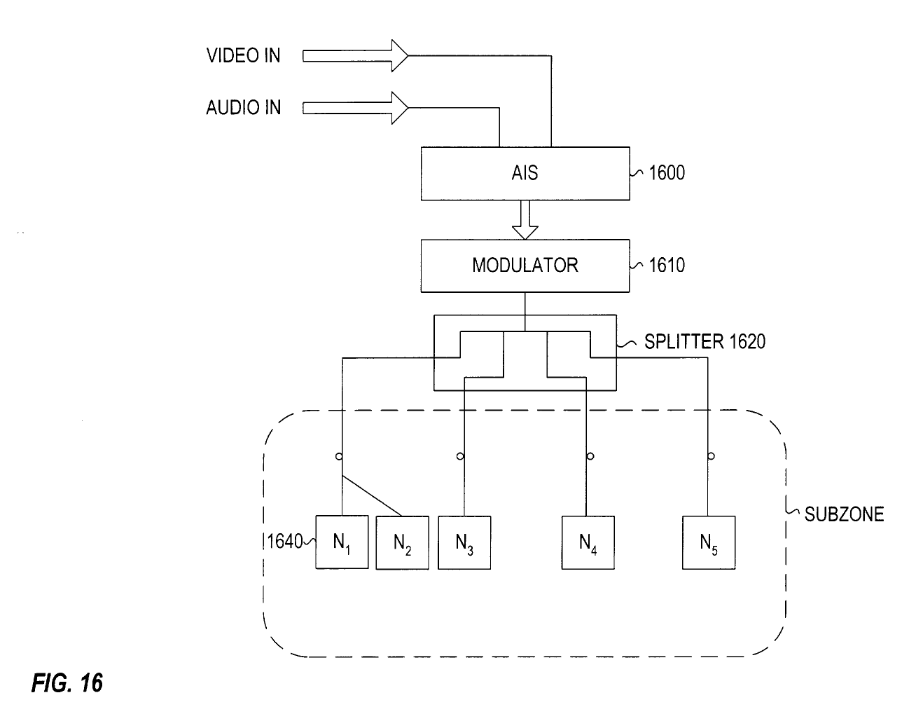

In order to target ads at the subzone level it is necessary for the head-end (subzone) to be able substitute ads. Thus, as illustrated in FIG. 16 each head-end requires an ad insertion system (AIS) 1600 capable of inserting targeted ads for the default ads, a modulator 1610 for modulating the signals at the appropriate frequency, and a splitter 1620 for splitting the signal so that it can be transmitted to each of the applicable nodes. As illustrated nodes N1, N2 are connected to the HE with the same fiber optic cable. The presentation stream (program stream with targeted ads) is transmitted to all nodes being fed from the HE, all branches from each node, and all subscribers connected to each branch.

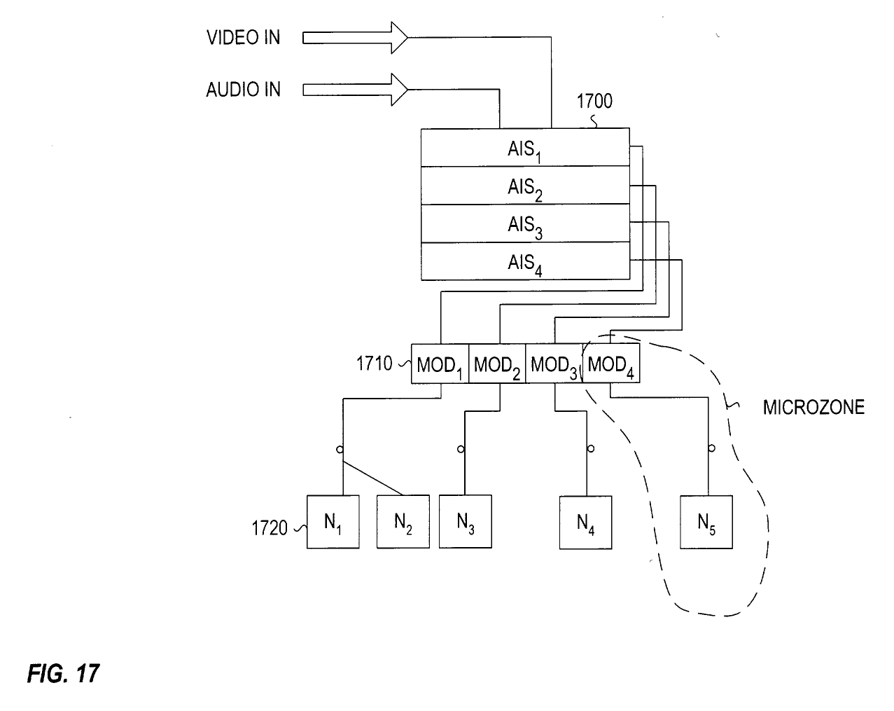

In order to target ads to the microzone each head-end must have a plurality of AISs. As illustrated in FIG. 17, the head-end consists of 4 separate AISs 1700 so that 4 separate presentation streams (program stream with targeted ads) can be generated. The head-end also includes a plurality of modulators 1710, equal in number to the number of AIS 1700, for modulating the presentation streams at the appropriate frequencies. Each presentation stream (program stream with targeted ads) is transmitted to the applicable nodes 1720, all branches of the nodes, and all subscribers connected to each branch. It should be noted that the same presentation stream can be transmitted to multiple nodes that are not restricted based on demographic area (node clusters).

In order to target ads to the branch it is necessary for each node to either be able to insert ads or to receive multiple presentation streams for the same program stream (at either different frequencies or different wavelengths) and be able to forward the appropriate presentation stream to the appropriate branch. As one skilled in the art would recognize, having each node equipped with ad insertion equipment would be a rather expensive option, and transmitting multiple presentation streams associated with the same program stream requires excessive bandwidth.

Targeting ads to a portion of the video delivery network is disclosed in more detail in Applicants' co-pending patent applications that have previously been incorporated by reference in their entirety (but not admitted to be prior art) and identified by docket numbers T719-00, T741-10 and T741-10PCT.

If the groups are not based on the CTV plant but are instead simply a random mix of subscribers and the targeted ads are inserted at the headend it would be necessary to transmit a plurality of presentation streams for each program stream and have the STB select the appropriate presentation stream. As discussed above with respect to the branch targeting, the presentation streams could be transmitted at different frequencies or wavelengths. However, as with the branch targeting this solution is bandwidth intensive.

Selecting targeted ads, inserting the ads in the program streams to create presentation streams, and delivering the presentation streams to the appropriate subscribers is disclosed in more detail in Applicants' co-pending patent applications that have previously been incorporated by reference in their entirety (but not admitted to be prior art) and identified by docket numbers T708-01, T708-02, T708-13, T711-01, T711-02, T711-03, T711-14, T712-10, T712-11, T721-15, T721-20, T741-10 and T741-10PCT.

As should be obvious to those of ordinary skill in the art, with the addition of targeting ads the UAQ has become more complex as it not only has multiple ad types to track but it may have multiple targeted ads for each type of avail. Accordingly, at a minimum, the UAQ has to been enhanced to include preferences for the group that individual subscribers (subscriber type) fall within. If the UAQ was stored at the HE and the HE was divided into five different target group, the UAQ would either have to identify preferences for each subscriber type or there would have to be five specific UAQs, one for each subscriber type. The headend would use the UAQ to determine which ads to insert in the programming in order to generate the five presentation streams. As one skilled in the art would recognize, it is possible that at certain times multiple presentation streams would be identical (have the same targeted ads selected for insertion into the programming). In these instances, fewer than the selected number (five in our example) of presentation streams would be generated and transmitted (i.e., nodes identified by different subscriber types would receive the same presentation stream).

According to one embodiment, the targeted ads are inserted at the subscriber end (PVR) according to the UAQ. In one embodiment, the ads are inserted according to the UAQ without regard to (or with limited regard to) what the subscriber is viewing. That is, the ads are inserted in the avails according to the schedule for that subscriber regardless of what program the subscriber is viewing at that point. This embodiment enables the advertiser to basically create a road block in which the subscriber will see the ad as they watch television as it will be inserted in the next avail. Targeted advertising at the PVR will be discussed in more detail later, but first an overall description of the PVR is provided.

The PVR is often thought of as a device located at the subscribers residence that enables a subscriber the ability to digitally store programming for subsequent viewing. However, the PVR is not limited to a device located at the subscribers residence and in fact can be located in its entirety within the video deliver system (i.e., at the headend) or may be functionally (and physically) split between the subscribers residence and the video deliver system. When used herein the term PVR refers to any type of device which digitally stores and inserts ads and stores and plays back programming (including video on demand programming), and can include devices located in the residence, the head-end or central office, in the distribution network, as part of the Internet, or distributed over any or all of these locations.

The PVR provides the basic functions of a VCR including record, play, rewind and fast forward. The PVR also includes functions that give a viewer the ability to manipulate live television programs by recording them simultaneously as they are being watched. This allows the viewer the ability to “pause” and have the program be recorded automatically (without hitting a Record button) and then resume watching the program by hitting Play. PVRs used to watch live programming allow the viewer to fast forward up to the current time, such that if pause was hit the viewer can return to the programming and advance through what was stored during the pause. Fast forward speeds typically include 5×, 20×, and 60×, but are clearly not limited thereto. PVRs also offer the ability to convert live program to a recording (“Convert to Recording” feature), return to live viewing (“Resume Live TV” feature), and clear the recording buffer upon a channel change.

Regardless of how a program was recorded on the PVR, during playback the PVR offers the viewer the ability to play, stop, pause, rewind, and fast forward through the recorded program. In addition, the PVR can support frame forward and frame backward features as well as digital slow motion, bookmark, and “go to time” features. An additional and controversial feature is the “Skip Forward” or “Commercial Skip” function, which some commercially available devices offer. Theses functions allow a user to skip forward exactly 30 seconds, effectively allowing the viewer to skip through commercials without seeing any portion of the ad or having to search for the return to programming. Clearly this feature will greatly reduce the effectiveness of typical/traditional program advertising.

A more detailed description of PVRs is disclosed in Applicants co-pending patent applications that have previously been incorporated by reference in their entirety (but not admitted to be prior art) and identified by docket numbers T738-00, T738-01 and T738-10.

However, from an advertiser's perspective, the PVR offers a tremendous range of possibilities for directing advertisements, both of the traditional 30 second type as well as various types of virtual advertisements and overlays, as will be described herein. The digital storage medium can store a large number of advertisements in addition to the recorded programming. The basic functionality of the PVR will allow for the insertion and splicing of these ads into playback material. The ads stored in the PVR will be ads determined to be relevant to the household (and individuals within the household). The ads in the PVR may be preloaded or may be delivered to the PVR via the delivery network (i.e., ad channel) or via a separate connection (i.e., Internet). The ads received at the PVR may be pre-filtered so that only ads applicable to that PVR are received. Alternatively, a plurality of ads can be received and the PVR filters the ads that are applicable thereto and stores those for later use.

The advertiser can use the PVR to achieve one-to-one marketing capability by insuring that the right ads are delivered to and ultimately displayed to the right viewers. Although it is technically possible to learn about each viewer individually, privacy concerns and the well-established mass advertising techniques used by major advertisers are likely to result in a migration to one-to-one advertising on PVRs through the formation of market segments as previously discussed. In forming market segments advertisers specify characteristics of the viewers they want to reach. These characteristics may include demographics and characteristics related to viewing habits. Ultimately these characteristics may include specific data, such as subscribers whose lease for a certain type or brand of vehicle is up in the next 6 months. Regardless of what the characteristics are that make up the market segments, the subscribers within each segment will be identified and will receive ads associated with those segments. To protect privacy the advertiser may not be provided with any user identifiable information, and in some cases will only know the number of individuals or households in the designated market segment. It is therefore possible to create very specific market segments without revealing personal information.

The PVR may have the ability to profile viewers and identify which viewer (or group of viewers) is interacting with the TV. Based on the viewer profiles and/or viewer identification, the PVR may select specific (targeted) advertisements. The ability to profile viewers and to identify viewers in a household based on their viewing characteristics is described in Applicants' co-pending patent applications that have previously been incorporated by reference in their entirety (but not admitted to be prior art) and identified by docket numbers T702-00, T702-02, T702-03, T702-04, T702-15, T703-00, T704-00, T704-01, T704-01PCT, T705-01, T505-02, T705-13, T721-10PCT, T734-10, T741-10 and T741-10PCT.

The PVR may be used to target ads at the subscriber end by selecting and inserting (or manipulating) the ads locally. The type of ads that may be inserted (or manipulated) include all of the various type of ads that have previously been discussed as well as some additional types of ads that are all discussed below:

Traditional programming ads (i.e., 30 second commercials) inserted in avails in live (as it is broadcast) television. Programming ads may also be inserted in VoD, PPV or recorded programming either in avails within the programming or may be pre or post pended to the content. May also be inserted in EPG avails.

Recorded programming ads are ads that are inserted in avails in programming as it is being recorded (either the same ads as in the live broadcast or separate ads) or as the programming is played back. If the recorded programming is played back multiple times the ads may change each time. Additional ads may also be displayed during playback of the video (pre or post pended ads). For additional disclosure see applicants' co-pending patent applications that previously incorporated by reference (but not admitted to be prior art) and identified by docket numbers T727-10, T727-10PCT and T728-10.

VoD programming ads (may be programming ads, infomercials, trailers, etc.) that are pre or post pended to the VoD content, or may be inserted within the content (at designated or created avails). VoD ads may also be inserted in PPV or recorded programming either in avails within the programming, or pre or post pended to the content. For additional disclosure see applicants' co-pending patent application that has previously been incorporated by reference in entirety (but not admitted to be prior art) and identified by docket numbers T742-00, T742-10 and T742-10PCT.

EPG ads (static or video) that are inserted in a portion of the EPG. If the ads are video ads they may in fact be programming ads, infomercials, or trailers that are reduced in size to fit within the EPG avail. For additional disclosure see applicants' co-pending patent application that has previously been incorporated by reference in entirety (but not admitted to be prior art) and identified by docket number T721-16, T723-00, T727-10, and T727-10PCT.

Channel change ads are ads that are inserted in the delay and thus blank/black screen that is often inherent in channel changes in digital cable or satellite based systems. These ads are either displayed in place of or in conjunction with the black screen. In a preferred embodiment, the channel change ads only take a portion of the screen (are displayed in conjunction with the black screen) to prevent a subscriber from thinking they are being forced to watch an ad between channel changes. Due to the short duration of these ads they are most likely static ads. For additional disclosure see applicants' co-pending patent application that has previously been incorporated by reference in entirety (but not admitted to be prior art) and identified by docket number T730-10.

Virtual ads that include product placements, overlays and bugs are inserted in the programming. Virtual ads may be inserted in live programming, recorded programming or VoD content. For additional disclosure see Applicants' co-pending applications that have previously been incorporated by reference in their entirety (but not admitted to be prior art) and identified by docket numbers T738-00 and T738-01.

Banner ads are ads that are displayed along the sides (top/bottom, left/right) of the screen in place of black screen that would be visible if the resolution of the programming is not in sync with the resolution of the display.

Having the ads stored on the PVR also offers the possibility of presenting ads to subscribers “on demand”. The subscribers may select the ads they wish to view from a menu or list that may be presented to the subscriber in the EPG. The ads may be categorized alphabetically, by product/service type, by target market, by style (i.e., funny, sappy), by subscriber preference, other know ways, or some combination thereof. Alternatively, the ads may be linked to an object in the programming (i.e., Pepsi can) or to a static ad (i.e., EPG ad) and the subscriber selects to receive the ad by clicking on the object (i.e., Pepsi can) in the programming or the static ad. Stored ads let viewers browse ads that they have determined have a high entertainment value. In addition, a payment/incentive system can be created to encourage viewers to watch ads. One advantage of stored ads is that the ads/themes/products that are of interested to the household can be easily identified by monitoring which ads they select and how many times they select them. Applicants' co-pending application that has previously been incorporated by reference (but not admitted to be prior art) and identified by docket number T740-00 describes the selection of ads in more detail.

Interactive ads, which require the subscriber to interact with the ad is some fashion, can also be utilized to deliver advertising to subscribers. The advantage of interactive advertisements is that the subscriber is participating in the advertisement, which is likely to have a significant and positive impact on recall. The interactive ad can also supply a vast amount of information to the viewer. In one embodiment, hyperlinks are presented in the ads that allow the user to access information from the Internet or stored on the hard drive.

As one of ordinary skill in the art would recognize, recorded programming and VoD programming offer the potential that subscribers may fast forward through, or skip advertisements. With the advent of the PVR in any of its various forms discussed above (or in Applicant's co-pending applications T738-00, T738-01, T738-10, T738-30), it is possible for the subscriber to record the programming and play it back in the future (potentially just a few minutes later) and fast forward through, or skip the advertisements. If the ads are fast-forwarded or skipped the value of the ad to the advertiser is diminished (or destroyed) as the subscriber doesn't see the ad or only sees illegible portions of the ad as it is fast-forwarded.

According to one embodiment, the value of the ad can be salvaged by replaying the fast-forwarding ad with an alternative shortened version of the ad. The alternative ad may be generated from the fast-forwarding ad or it may be a separate ad. The alternative ad may be a portion of video of the fast-forwarding ad (i.e., the first 2 seconds, first second and last second), a single image, a combination of still image and video, a modification of video, still image or combination thereof (i.e., addition of graphics), or not be based on the fast forwarding ad at all. The alternative ad may be displayed in place of the fast-forwarding ad or in conjunction with the fast-forwarding ad (i.e., split screen, picture-in-picture). The alternative ad may be generated from the ad by applying rules that are either specific to the ad or are general and can be used for generating a replacement for any fast-forwarding ad.

The alternative ads are in effect another form of avail. According to one embodiment, this feature would be available to any advertiser as long as they either defined the rules to apply to the ad, identified a separate ad to play in the event of a fast-forward, or generated the ad in such a fashion that generic rules could generate the alternative ad. According to another embodiment, the advertisers would have to pay a premium for this protection to their advertising value (i.e., pay for these new avails). According to another embodiment, alternative advertisers could purchase the avails that become available when ads are fast-forwarded. For example, Coke could pay to insert a shortened Coke ad in place of a fast-forwarding Pepsi ad. It should be noted that the display of alterative ads is not limited to fast-forward events but can also occur during skip, rewind or other VCR type functions that are often replayed to as “trick-play”. Applicants ADhance™ technology handles the displaying (and generation when applicable) of the alternative ads during trick-play events and is described in applicants' co-pending patent application previously incorporated by reference (but admitted to be prior art) and identified by docket number T738-10.

The PVR has the ability to insert ads targeted for the subscriber regardless of what time it is or what program is being watched. Thus, while the subscriber may be part of a particular market segment the ads associated with that market segment are specifically delivered to that subscriber according to an individualized schedule. The PVR accomplishes this by inserting ads into the next avail based on an ad queue. As each subscriber's viewing patterns will be different, the delivery of the ads from the ad queue will be different. If no preferences are defined in the ad queue, then the main difference will be the time at which the ads were inserted based on when the subscriber was viewing the TV. For example, assume the first ad in the queue for subscribers belonging to the market segment “young and wealthy” was an ad for BMW. A first subscriber viewing programming may receive the ad at before they go to work at 7 am (first avail), while the second subscriber may see that ad during dinner (first avail). As would be obvious to one of ordinary skill in the art if preferences are added to the ad queue, the difference between the actual display of ads for subscribers in the same market segment may increase. For example, if the BMW ad had a preference that it not be displayed at dinner time, the ad would not even be the first ad displayed to subscriber 2.

As an ad queue generated for a specific market segment can generate different results when inserting ads at the PVR, in a preferred embodiment the UAQ would be maintained at the PVR. According to one embodiment, each market segment (and all the PVRs associated therewith) would receive a separate UAQ associated with that market segment. Alternatively, each PVR would receive the same UAQ and the UAQ would include a preference for market segment and each PVR would adjust the UAQ based on the market segment assigned thereto. It is possible that a single PVR is associated with more than one market segment if the subscribers (or group of subscribers) interacting with the PVR have different traits associated therewith and the different traits align with different market segments. In this case, the PVR would either have more than 1 UAQ (1 for each market segment) or the PVR would have a single UAQ with more than 1 market segment preference assigned thereto.

The PVR also offers the advertiser more flexibility in defining their ad campaign, as the campaign will be tailored to each subscriber based on their viewing patterns. Thus, the advertiser may define the ad campaign more loosely and not tie placement of ads to specific programs or types of ads. For example, an advertiser may be more willing to define high level criteria for the ad campaign (i.e., total of 100 ads placed per subscriber, total of $2000 per subscriber) and allow the UAQ in the PVR to determine the exact ads that are delivered to each subscriber. According to one embodiment, a UAQ may be an ordered list of ads to display that is not based (at least for the most part) on the type of avails. That is, for each advertiser the UAQ provides an ad for multiple ad types and based on the next avail the appropriate ad type is selected for that advertiser.

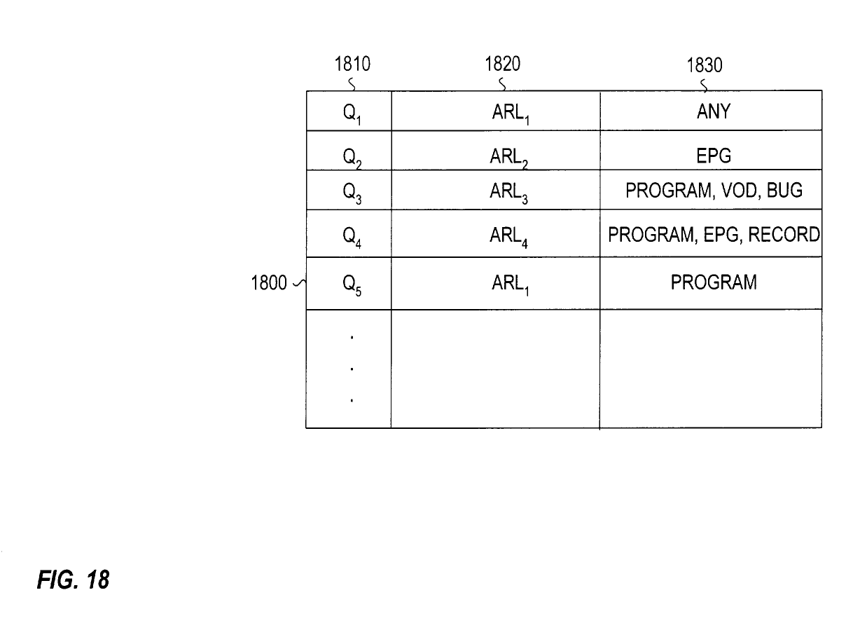

FIG. 18 illustrates an exemplary UAQ 1800 in which each slot 1810 has an ad 1820 identified by ARL and a description 1830 of the avails that the ad can be placed in. As illustrated, ARL1 which is in slot Q1 can be placed in any type of avail, while ARL 2 in Q2 can only be placed in EPG avails. The exemplary UAQ 1800 does not list a separate ad for each avail type. As would be obvious to one of ordinary skill in the art a single ad is not likely to be able to be placed in the multiple avail types.

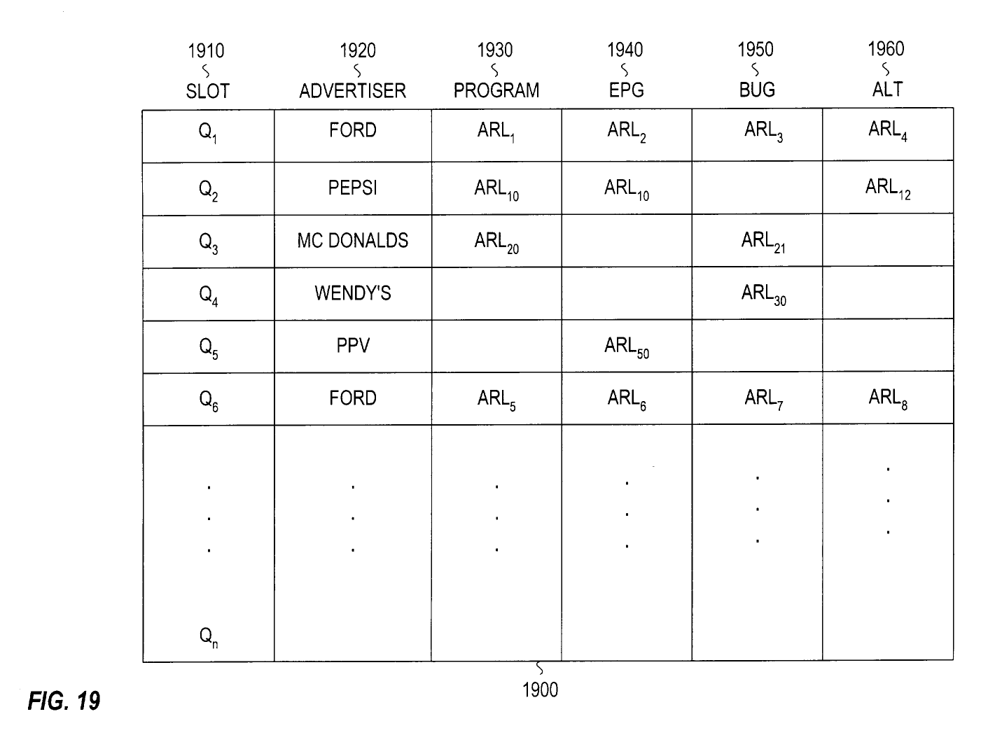

FIG. 19 illustrates an exemplary UAQ 1900 that has specific advertisers 1920 associated with each slot 1910 in the UAQ 1900. Each advertiser 1920 then has different ad types defined for the specific company, product, or service. As illustrated, the UAQ includes ARLs for programming ads (i.e., typical 30 second commercial) 1930, EPG ads 1940, Bugs 1950, and alternative ads 1960. The next ad to be inserted is based on the next avail to be available. For example, if the first avail is an EPG avail, the Ford EPG ad will be retrieved from ARL2. In the case of Ford (Q1), a Ford ad would have been displayed regardless of the avail type. However, it should be noted that some advertisers may not have or want ads associated with certain avails. For example, Pepsi (Q2) does not have a bug ad associated therewith. Thus, if Pepsi was next in the queue but a bug avail was the next avail, Pepsi would be skipped over and replaced with McDonalds (Q3) as McDonalds would have been next in the queue. The McDonalds bug ad would then be retrieved from ARL21. Pepsi would remain the top advertiser in the queue and a Pepsi ad would be selected in the next avail that was not a bug avail. It should be noted that as illustrated the Pepsi programming ads and EPG ads are the same (both selected from ARL 10). Accordingly, regardless of which avail type was presented first when Pepsi was at the top of the UAQ 1900, the same ad would be displayed. It is likely, although not limited to, that the ad in ARL10 is a programming ad (i.e., 30 second commercial) and that the ad would be reduced in size to fit within the ad window in an EPG if the ad was selected for an EPG avail.

As would be obvious, advertisers may exist multiple times in the queue. The placement of the advertisers in the queue may be random, may be based on all the different criteria provided for each advertiser, may be based on a formula (i.e., Qnew=Qold+5), or some combination thereof. For example, Ford is in slot Q1 and slot Q6. As illustrated, all of the ad types associated with Ford in Q6 are different than those in Q1. However, as one of ordinary skill in the art would recognize, the ads need not be new ads each time, some or all of the ad types may have the same ads. According to one embodiment, the only ad type that will have a new ad is the ad type was displayed the previous time. As one skilled in the art would recognize there are numerous ways in which the ads associated with the different ad types for a particular advertiser can be managed within the UAQ that would be well within the scope of the current invention.

The exemplary UAQs of FIGS. 18 and 19 are simply exemplary embodiments and in no way are intended to limit the scope of the current invention. As one skilled in the art would recognize there are numerous other embodiments that are well within the scope of the current invention.

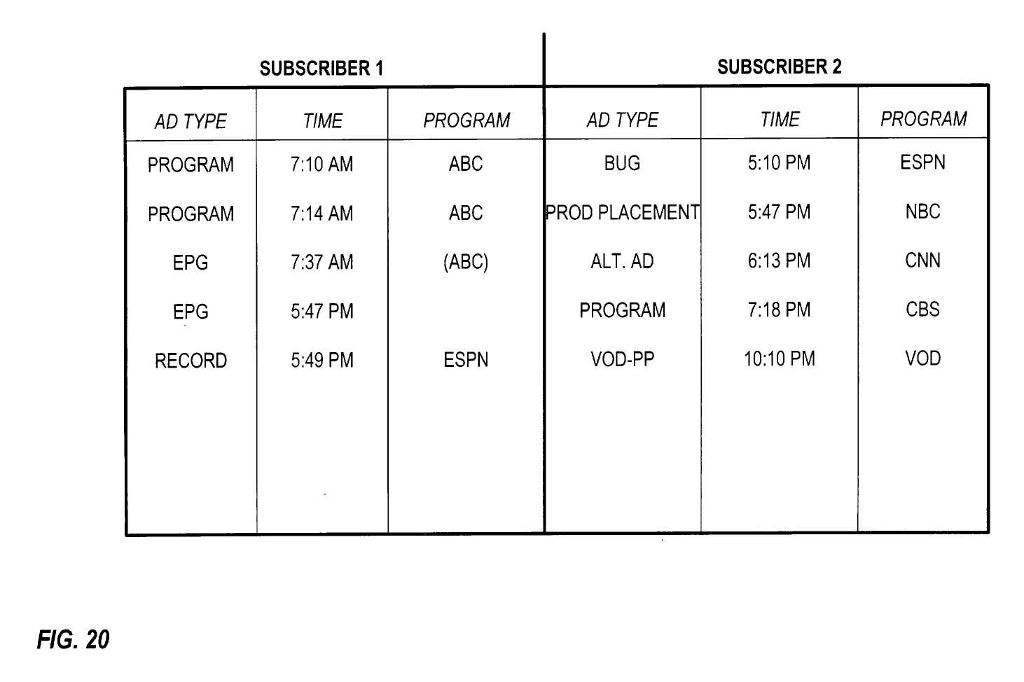

With the added personalization provided by the PVR (UAQ generating an unique ad campaign even though the UAQ is applicable to an entire market segment), the advertiser may, for example, define their ad campaign for the month of March 2002 for the “Middle Age” market segment as placing one of their ads (regardless of type) in every fifth avail until 100 ads have been displayed. Accordingly, the advertiser would have to provide an ad for each of the various types of avails so that if that avail type presents itself, the ad can be inserted therein. FIG. 20 illustrates an exemplary playlist for the advertiser identified above (place ad in every fifth avail) of when and what type of ads where inserted for two separate subscribers within the Middle Age” market segment. For example, the first ad was presented as a program ad at 7:10 am on ABC for subscriber 1 and was presented as a bug at 5:10 pm on ESPN for subscriber 2. Looking at the third ad, it was displayed to the first subscriber in the EPG (that was activated when the subscriber was watching ABC) at 7:37 am, while the third ad is displayed as an alternative ad (meaning the ad was recorded and during playback a trick play event such as a fast-forward or skip command was encountered) at 6:13 pm on CNN.

The exemplary embodiment of FIG. 20 could also represent an overall playlist of ads for the subscribers if it included an ad column for each subscriber. The ads displayed to the subscribers may be the same for each subscriber or may be different depending on whether the UAQ includes any preferences/restrictions (i.e., time, channel, program) and whether each ad in the UAQ is associated with each type of avail. If the UAQ did not have any preferences (it was simply an ordered list) and each ad supported all avail types then the ads associated with each row (avail) for subscriber 1 and subscriber 2 would be for the same product, service, or company as they would have been taken in order out of the UAQ as the avails presented themselves. As would be obvious to one of ordinary skill in the art, if the UAQ contained preferences/restrictions of if each had did not support all avail types the ads associated with each subscriber would not be the same. That is, the ads associated with the avails for subscriber 1 could be ad1-ad5 in order, while the ads associated with subscriber 2 could be ad1, ad3 (ad2 did not support product placement), ad2, ad5 (had preference over ad4 for some reason), and ad4.

The PVR can also report statistics about which ads were displayed to the subscriber. Moreover, if applicable to the price charged to advertisers the PVR can also report when (time) and where (channel) the ads were displayed. In addition the PVR can provide information with respect to the effectiveness of the advertising (i.e., to what degree the ad was watched to completion, if the channel was changed to avoid the ad, if the ad was fast forwarded and if so was it replaced with an alternative ad). This reporting may be done when requested from the video delivery network (specifically the traffic and billing system) or it may be transmitted to the T&B system at set intervals (i.e., once a week). When transmitting the data, no identification information would be transmitted. Moreover, according to one embodiment the T&B system would aggregate the data and provide the aggregate data to the advertisers so that no personal information was given out and the privacy of the subscribers is maintained.

According to one embodiment, the UAQ may be modified based on the actions of the subscriber. That is, the UAQ may learn about the subscriber and modify the UAQ to be more in line with the subscriber. The modification of the UAQ may be based on rules associated with the subscriber's actions. The rules may be rules provided by the advertisers in the development of the UAQ, general rules applied to all UAQs, rules that are based on a profile of the subscriber developed by the PVR, other types of rules now known or later developed, or some combination thereof. The rules may modify the order of the UAQ, may remove ads from the UAQ, may add ads to the UAQ, may add limitations (preferences/restrictions/links) to the UAQ, or make other modifications that would be obvious to those of ordinary skill in the art. Examples of ads that may be removed or added include, but are not limited to specific ads (i.e., Brittany Spears Pepsi® ad), specific company ads (i.e., Pepsi®), ads for a particular product type (i.e., beer), specific type of ads (i.e., EPG), or specific genre of ad (i.e., funny ads). The rules may be applied after each ad, after each specific action a subscriber takes while viewing an ad (i.e., skip or fast forward ad, change channel, raise or lower volume), at fixed intervals (i.e., once a day), when the PVR determines that it is in order, or some combination thereof. Applicants' co-pending patent application previously incorporated by reference in its entirety (but not admitted to be prior art) and identified by docket number T738-30 discloses the behavioral ad queue in more detail.

The invention has been described with specific emphasis on video. The invention is not limited thereto. The invention may be applied to audio, Internet, email, postal mail, magazines, newspapers, or other types of media that have ads inserted therein. According to one embodiment the invention may be applicable to any type of ads that can be delivered to a subscriber via an in home network (i.e., audio, video, Internet, email). The UAQ for the in home network would define all of the various types of avails and the relationships therebetween. In a preferred embodiment, the UAQ would be stored in the in-home networking device so that it could monitor the avails for each of the media and the ads that were inserted therein. According to one embodiment, the PVR could be the in home networking device. However, the in home networking device could be numerous other devices that would be obvious to those of ordinary skill in the art. The current invention is intended to cover all of these different embodiments.

Although this invention has been illustrated by reference to specific embodiments, it will be apparent to those skilled in the art that various changes and modifications may be made which clearly fall within the scope of the invention. The invention is intended to be protected broadly within the spirit and scope of the appended claims.

What is claimed is:

1. A method for coordinating the display of various advertisement types to subscribers, the method comprising
detecting an avail, wherein the avail detected can be for at least two different types of advertisements;
querying a universal ad queue to determine which advertisement should be inserted in the avail, wherein the universal ad queue provides an ordered list for at least two different types of advertisements;
retrieving the advertisement;
inserting the advertisement in the avail; and
delivering the advertisement to the subscriber.

2. The method of claim 1, wherein the at least two different type of advertisements include at least some combination of programming advertisements, EPG advertisements, product placement advertisements, overlay advertisements, bug advertisements, banner advertisements, recorded advertisements, VoD advertisements, and alternative advertisements.

3. The method of claim 1, wherein the universal ad queue identifies where the advertisements are located.

4. The method of claim 1, wherein the universal ad queue utilizes advertisement resource locaters to identify location of the advertisements.

5. The method of claim 1, wherein the universal ad queue is a single ad queue providing an ordered list for the at least two different types of advertisements.

6. The method of claim 1, wherein the universal ad queue is a plurality of ad queues that are linked together in some fashion.

7. The method of claim 1, wherein the universal ad queue is maintained in one location.

8. The method of claim 7, wherein the one location is a video delivery network that provides programming in which the advertisements are inserted.

9. The method of claim 7, wherein the one location is at a subscriber end.

10. The method of claim 9, wherein the universal ad queue is maintained within a set top box at the subscriber end.

11. The method of claim 1, wherein the universal ad queue is maintained at multiple locations.

12. The method of claim 11, wherein the universal ad queue is maintained by some combination of a set top box at the subscriber end and a video delivery network.

13. The method of claim 1, wherein the universal ad queue includes links between the various advertisement types.

14. The method of claim 13, wherein the links may be positive or negative.

15. The method of claim 1, wherein the universal ad queue includes criteria for each advertisement type.

16. The method of claim 15, wherein the criteria are related to at least some subset of time, program, network, and subscriber type.

17. The method of claim 15, wherein the criteria are either preferences or restrictions.

18. The method of claim 15, wherein the criteria are weighted.

19. The method of claim 1, wherein each advertisement type within the universal ad queue has its own queue.

20. The method of claim 1, wherein the universal ad queue has a single queue for all different advertisement types.

21. The method of claim 1, wherein at least some subset of the advertisements are targeted advertisements.

22. The method of claim 21, wherein the targeted advertisements are targeted to at least some subset of headend, microzone, branch, subscriber, individual, or subscriber type.

23. The method of claim 1, wherein said inserting is performed at a video delivery network.

24. The method of claim 1, wherein said inserting is performed at a personal video recorder.

25. The method of claim 24, wherein the personal video recorder is located at a subscriber side.

26. The method of claim 24, wherein the personal video recorder is located at a video delivery network.

27. The method of claim 24, wherein the personal video recorder is distributed between a video delivery network and a subscriber side.

28. The method of claim 1, further comprising generating the universal ad queue by processing instructions from a plurality of advertisers, wherein the instructions define how the advertisers wish to present their advertisements.

29. The method of claim 28, further comprising retrieving the instructions from the plurality of advertisers.

30. The method of claim 29, wherein said retrieving includes providing a user interface for the advertisers to enter the instructions.

31. The method of claim 1, further comprising
monitoring the advertisements from the universal ad queue that are inserted; and
updating the universal ad queue based on said monitoring.

32. A system for coordinating the display of various advertisement types to subscribers, the system comprising
means for detecting an avail, wherein the avail detected can be for at least two different types of advertisements;
means for querying a universal ad queue to determine which advertisement should be inserted in the avail, wherein the universal ad queue provides an ordered list for at least two different types of advertisements;
means for retrieving the advertisement;
means for inserting the advertisement in the avail; and
means for delivering the advertisement to the subscriber.

33. The system of claim 32, further comprising means for generating the universal ad queue by processing instructions from a plurality of advertisers, wherein the instructions define how the advertisers wish to present their advertisements.

34. The system of claim 32, further comprising means for retrieving the instructions from the plurality of advertisers.

35. The system of claim 34, wherein said means for retrieving is a user interface for the advertisers to enter the instructions.

36. The system of claim 32, further comprising
means for monitoring the advertisements from the universal ad queue that are inserted; and
means for updating the universal ad queue responsive to said means for monitoring.

37. A computer program embodied on a computer-readable medium for coordinating the display of various advertisement types to subscribers, the computer program comprising:
a source code segment for detecting an avail, wherein the avail detected can be for at least two different types of advertisements;
a source code segment for querying a universal ad queue to determine which advertisement should be inserted in the avail, wherein the universal ad queue provides an ordered list for at least two different types of advertisements;
a source code segment for retrieving the advertisement;
a source code segment for inserting the advertisement in the avail; and
a source code segment for delivering the advertisement to the subscriber.

38. The computer program of claim 37, further comprising a source code segment for generating the universal ad queue by processing instructions from a plurality of advertisers, wherein the instructions define how the advertisers wish to present their advertisements.

39. The computer program of claim 38, further comprising a user interface for receiving the instructions from the plurality of advertisers.

40. The computer program of claim 37, further comprising
a source code segment for monitoring the advertisements from the universal ad queue that are inserted; and
a source code segment for updating the universal ad queue responsive to said means for monitoring.

41. A method for generating a universal ad queue, the method comprising
receiving instructions from a plurality of advertisers, wherein the instructions define their advertisement campaign for associated advertisements, including at least some subset of type of advertisements, preferences, links with other advertisements or advertisement types, and number of times to be displayed; and
processing the instructions to create the universal ad queue, wherein the universal ad queue provides an ordered list for at least two different types of advertisements.

42. The method of claim 41, wherein said receiving is performed at a user interface provided to the advertisers.

43. The method of claim 41, wherein the at least two different type of advertisements include at least some combination of programming advertisements, EPG advertisements, product placement advertisements, overlay advertisements, bug advertisements, banner advertisements, recorded advertisements, VoD advertisements, and alternative advertisements.

44. The method of claim 41, wherein the universal ad queue identifies where the advertisements are located.

45. The method of claim 41, wherein the universal ad queue utilizes advertisement resource locaters to identify location of the advertisements.

46. The method of claim 41, wherein the universal ad queue is a plurality of ad queues that are linked together in some fashion.

47. The method of claim 41, wherein the universal ad queue is maintained in one location.

48. The method of claim 47, wherein the one location is a video delivery network that provides programming to the subscriber.

49. The method of claim 47, wherein the one location is at a subscriber end.

50. The method of claim 49, wherein the universal ad queue is maintained within a set top box at the subscriber end.

51. The method of claim 41, wherein the universal ad queue is maintained at multiple locations.

52. The method of claim 41, wherein the universal ad queue includes links between the various advertisement types.

53. The method of claim 52, wherein the links may be positive or negative.

54. The method of claim 41, wherein the universal ad queue includes criteria for each advertisement type.

55. The method of claim 54, wherein the criteria are related to at least some subset of time, program, network, and subscriber type.

56. The method of claim 54, wherein the criteria are either preferences or restrictions.

57. The method of claim 54, wherein the criteria are weighted.

58. The method of claim 41, wherein each advertisement type within the universal ad queue has its own queue.

59. The method of claim 41, wherein the universal ad queue has a single queue for all different advertisement types.

60. The method of claim 41, wherein at least some subset of the advertisements are targeted advertisements.

61. The method of claim 41, further comprising
selecting ads from the universal ad queue; and
inserting the ads in avails within programming.

62. The method of claim 61, further comprising
monitoring said inserting; and
updating the universal ad queue based on said monitoring.

63. A system for generating a universal ad queue, the system comprising
means for receiving instructions from a plurality of advertisers, wherein the instructions define their advertisement campaign for associated advertisements, including at least some subset of type of advertisements, preferences, links with other advertisements or advertisement types, and number of times to be displayed; and
means for processing the instructions to create the universal ad queue, wherein the universal ad queue provides an ordered list for at least two different types of advertisements.

64. The method of claim 63, wherein said means for receiving is a user interface provided to the advertisers.

65. The system of claim 63, further comprising a database for storing the universal ad queue.

66. The system of claim 65, wherein said database is a distributed database.

67. The system of claim 63, further comprising
means for selecting ads from the universal ad queue; and
means for inserting the ads in avails within programming.

68. The system of claim 67, further comprising means for updating the universal ad queue responsive to said means for inserting.

69. A computer program embodied on a computer-readable medium for generating a universal ad queue, the computer program comprising
a source code segment for receiving instructions from a plurality of advertisers, wherein the instructions define their advertisement campaign for associated advertisements, including at least some subset of type of advertisements, preferences, links with other advertisements or advertisement types, and number of times to be displayed; and
a source code segment for processing the instructions to create the universal ad queue, wherein the universal ad queue provides an ordered list for at least two different types of advertisements.

70. The computer program of claim 69, wherein said source code segment for receiving is a user interface that allows advertisers to enter the instructions.

71. The computer program of claim 69, further comprising a database for storing the universal ad queue.

72. The computer program of claim 69, further comprising
a source code segment for selecting ads from the universal ad queue; and
a source code segment for inserting the ads in avails within programming.

73. The computer program of claim 72, further comprising a source code segment for updating the universal ad queue responsive to said source code segment for inserting.

74. A personal video recorder for presenting advertisements to a subscriber, the personal video recorder comprising:
an interface for receiving video programming;
a universal ad queue containing an ordered list of at least two different types of advertisements;
a detector for detecting avails within the video programming;
a selector for selecting an advertisement from the universal ad queue for insertion in the avail;
an inserter for inserting the advertisement into the avail; and
a modulator for modulating the video programming with the advertisement inserted therein to the subscriber.

75. The personal video recorder of claim 74, further comprising a database containing a plurality of advertisements, wherein at least a subset of the plurality of advertisements are listed in the universal ad queue.

76. The personal video recorder of claim 75, wherein the database is a distributed database.

77. The personal video recorder of claim 74, wherein the at least two different type of advertisements include at least some combination of programming advertisements, EPG advertisements, product placement advertisements, overlay advertisements, bug advertisements, banner advertisements, recorded advertisements, VoD advertisements, and alternative advertisements.
